(19) United States
(12) Patent Application Publication
(10) Pub. No.: US 2015/0054683 A1
(43) Pub. Date: Feb. 26, 2015

(54) BEACON WITH INTERNAL GEOGRAPHIC LOCATION TRACKING THAT TRANSMITS THE LOCATION IN A BEACON TRANSMISSION

(71) Applicant: Times Three Wireless Inc., Calgary (CA)

(72) Inventors: Michael Hryciuk, Calgary (CA); Andrew Borsodi, Calgary (CA)

(73) Assignee: Times Three Wireless Inc., Calgary (CA)

(21) Appl. No.: 13/975,249

(22) Filed: Aug. 23, 2013

(51) Int. Cl. G01S 19/13

(52) U.S. Cl. CPC G01S 19/13
USPC 342/357.51

(57) ABSTRACT

Systems, methods and apparatus are provided through which in some implementations a geographic location of a beacon is determined by a component integrated within or in close proximity to the beacon and the geographic location is communicated to an external network using a wireless communications channel between the beacon and the external network.

### BACKGROUND

1. Field

This disclosure relates generally to geographic location tracking, and more particularly to wireless geographic location tracking of mobile devices.

2. Description of Related Art

The Naystar Global Positioning System (GPS) or other satellite-based navigation systems (e.g. GLONASS, Galileo, Compass) are referred to in aggregate as Global Navigation Satellite System (GNSS).

In addition, other devices provide geographic location data of a device.

### BRIEF DESCRIPTION

The subject matter of this disclosure reduces the quantity of equipment, the deployment cost of the equipment, and the operating cost of the equipment required to support a large number of beacons used for the transfer of data from the beacon to the network, transfer of data from the network to the beacon and transfer of data comprising of the geographic location of the beacon to the network, allows the use of the network to capture market needs that are currently not being serviced due to the cost of competing services that exceeds the value of the service to the customer and allows the use of the network to capture market needs that are currently being serviced by more costly services.

In one aspect, a computer-accessible medium has processor-executable instructions for wireless communication from a beacon to a network base station receiver, the processor-executable instructions capable of directing a processor to perform receiving GNSS information from a GNSS receiver, calculating a geographic location estimate from the GNSS information, where the geographic location estimate is selected from a group of geographic location estimations in a geographical coordinate system consisting of a stationary 2-dimensional geographic location, a stationary 3-dimensional geographic location, a kinematic 2-dimensional geographic location and a kinematic 3-dimensional geographic location, calculating a velocity and a direction of travel from the GNSS information, transmitting a here-i-am (HIA) transmission on a first radio frequency channel of 12 radio frequency channels of a first pseudo-random frequency hopping pattern, the HIA transmission including identification of a second radio frequency channel of 42 radio frequency channels, wherein the HIA transmission is a short transmission that does not include a serial number of the beacon, and transmitting a beacon transmission that includes the geographic location, the velocity and the direction of travel, wherein the 12 radio frequency channels and the 42 radio frequency channels are mutually exclusive and have no radio frequency channels in common between the 12 radio frequency channels and the 42 radio frequency channels.

In another aspect, a method of a beacon includes receiving GNSS information from a GNSS receiver, estimating a geographic location from the GNSS information, transmitting a here-i-am (HIA) transmission on a first radio frequency channel, to notify a network base station receiver that the beacon is in range of the network base station receiver to access the network base station receiver, to alert to the network base station receiver as to a presence of the beacon and to notify to the network base station receiver of a second radio frequency channel, and transmitting on another radio frequency channel a beacon transmission that includes the geographic location.

In yet a further aspect, an apparatus includes a first component of processor-executable instructions that are operable to receive GNSS information from a GNSS receiver, a second component of processor-executable instructions that are operable to calculate a geographic location from the GNSS information, a third component of processor-executable instructions that are operable to cause a first transmission from a beacon on a first radio frequency channel, the first transmission providing detection of the beacon by a network base station receiver, and another component of processor-executable instructions that are operable to cause another transmission from the beacon, the other transmission including the geographic location.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of a system including a beacon that determines a geographic location from GNSS signals and transmits the geographic location to a network through a network base station receiver, according to an implementation.

FIG. 2 is a block diagram of a apparatus that is capable of wireless communication of GNSS geographic location using two messages between a beacon and a network base station receiver, according to an implementation;

FIG. 3 is a block diagram of a apparatus that is capable of wireless telemetry communication of GNSS geographic location using three messages between a beacon and a network base station receiver, according to an implementation;

FIG. 4 is a block diagram of a apparatus that is capable of wireless telemetry communication of GNSS geographic location using three messages between a beacon and a network base station receiver, according to an implementation;

FIG. 5 is a block diagram of a apparatus that is capable of wireless telemetry communication of GNSS geographic location using three messages between a beacon and a network base station receiver, according to an implementation;

FIG. 6 is a flowchart of a method of a beacon receiving complete GNSS information and transmitting the geographic location of the beacon, according to an implementation;

FIG. 7 is a flowchart of a method of wireless telemetry communication from a beacon to a network base station receiver, according to an implementation;

FIG. 8 is a flowchart of a method of wireless geographic location tracking communication from a beacon to a network base station receiver, according to an implementation;

FIG. 9 is a flowchart of a method of a beacon tracker locating a beacon from complete GNSS geographical location information received by the network from a beacon transmission, according to an implementation.

FIG. 10 is a flowchart of a method of wireless telemetry communication at a network base station receiver, according to an implementation;

FIG. 11 is a flowchart of a method of wireless communication for geographic location tracking at a network base station receiver, according to an implementation;

FIG. 12 illustrates an example of a general computer environment useful in the context of the other figures, according to an implementation;

FIG. 13 is a block diagram of a telemetry beacon hardware environment, according to an implementation;

FIG. 14 is a block diagram of a GNSS receiver hardware environment, according to an implementation;

FIG. 15 is a block diagram of a network base station receiver hardware environment, according to an implementation;

FIG. 16 is a diagram of protocol stack layers for a HIA Burst, according to an implementation;

FIG. 17 is a diagram of protocol stack layers for a REG Burst, according to an implementation;

FIG. 18 is a diagram of protocol stack layers of a SIM Packet, according to an implementation;

FIG. 19 is a diagram of the timing and synchronization points for geographic location tracking application using HIA and REG Bursts, and for the telemetry application using HIA and REG and SIM Bursts, according to an implementation;

FIG. 20 is a diagram of a linear feedback shift register (LFSR) generator, according to an implementation;

FIG. 21 is a flowchart of SIM channel sequence generation per given CSN and WIN, according to an implementation;

FIG. 22 is a diagram of an encapsulation of network-access related information for a HIA Burst, according to an implementation;

FIG. 23 is a diagram of an encapsulation of network-access related information for a REG Burst, according to an implementation;

FIG. 24 is a diagram of an encapsulation of geographic location related information for a REG Burst, according to an implementation; and

FIG. 25 is a diagram of an encapsulation of a segmented encoded telemetry uplink message for a SIM Burst, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into six sections. In the first section, a system level overview is described. In the second section, implementations of apparatus are described. In the third section, implementations of methods are described. In the fourth section, hardware and the operating environments in conjunction with which implementations may be practiced are described. In the fifth section, implementations of the protocols are described. In the sixth section, a conclusion of the detailed description is provided.

### System Level Overview

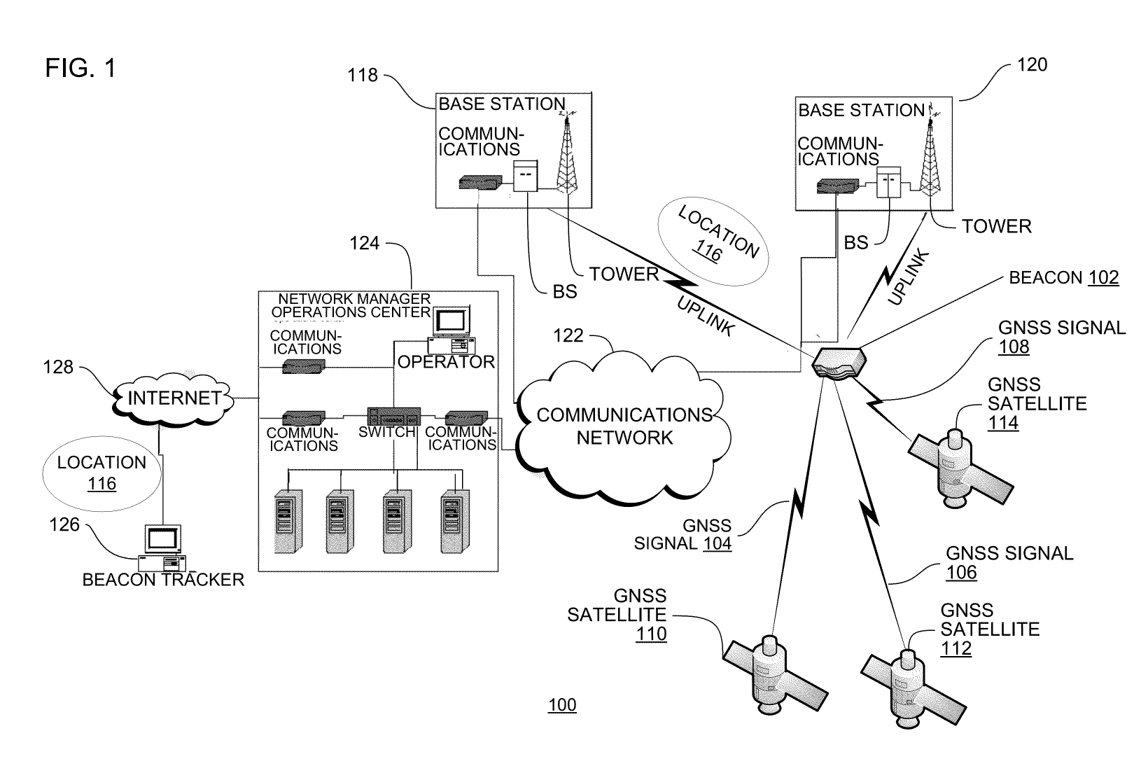

FIG. 1 is a block diagram of a system 100 including a beacon that estimates a geographic location in either 2D or 3D format from an external reference and transmits the geographic location to a network through a network base station receiver, according to an implementation. System 100 includes a beacon 102 that determines a geographic location of the beacon from an external reference. In the example shown in FIG. 1, the beacon 102 receives GNSS signals from GNSS satellites, such as GNSS signals 104, 106 and 108 from GNSS satellites 110, 112 and 114 respectively. In other implementations where 3D geographic location is required, the beacon 102 receives GNSS signals from at least 4 GNSS satellites (not shown). Other examples of external geographic location references include accelerometers, dead-reckoning systems, wheel rotation sensors, gyroscopes, compass heading and vehicle tire rotation sensors.

The beacon 102 calculates a geographic location 116, such as a latitude and longitude, from the GNSS geographic location signals and transmits the geographic location 116 to one or more network base station receivers 118 and 120 that are operable to receive communication via radio frequency channels from the beacon 102. The network base station receivers 118 and 120 send the geographic location 116 through a communications network 122 to a network manager operations center 124. The network manager operations center 124 sends the geographic location 116 to a beacon tracker 126 through the Internet 128. In other implementations not shown, the beacon tracker 126 is a component in the network manager operations center 124. The beacon tracker 126 uses the geographic location 116 to track the beacon. The geographic location 116 being calculated or determined by the beacon 102 and then transmitted to network base station(s) 118 and/or 120 eliminates location-based processing on the network manager operations center 124 and the beacon tracker 126. The geographic location 116 that is estimated, calculated or determined by the beacon 102 is not detrimental to the timeliness of calculating or determining the geographic location 116 because the beacon 102 typically has sufficient processing capability to calculate or determine the geographic location 116 in a timely manner. Therefore, estimating, calculating or determining the geographic location 116 by the beacon 102 is helpful by eliminating the processing burden of estimating, calculating or determining the geographic location 116 on uplink components such as the base station 118, the network manager operations center 124 or the beacon tracker 124. In addition, the bandwidth requirements of sending GNSS information from the beacon 102 to the network manager operations center 124 in order to calculate or determine the geographic location 116 of the beacon 102 is significantly larger than that of the beacon 102 sending the geographic location 116 to the network manager operations center 124. The lower bandwidth requirement results in lower network equipment costs and lower network operating costs to support the number of deployed beacons and also reduce network resource contention of numerous beacons accessing the network. Calculating or determining the geographic location 116 at the beacon 102 eliminates the processing load of calculating or determining the geographic location 116 on the network manager operations center 124 and/or on the beacon tracker 126, furthermore it takes advantage of availability of processor resources on the beacon 102 to calculate or determine the geographic location 116. In some implementations, the beacon 102 is a hybrid beacon that includes both a GPS receiver that generates a location 116 of the GPS receiver and components that are operable to transmit the location 116 in a protocol to a base station receiver.

In other implementations, the geographic location 116 also includes altitude. The altitude is very important for urban areas in which the beacon could be on any one of a number of floors of a building and determining the exact floor of the building is necessary or helpful to either recover or provide geographic location services of the beacon and an object to which the beacon is attached.

In other implementations, the geographic location 116 also includes a velocity and a direction of travel. The velocity and the direction of travel is beneficial in predicting plausible future geographic locations for tracking the beacon and an object to which the beacon is attached, which in turn can be very important in either recovering or providing geographic location services of the object to which the beacon is attached. Furthermore, the velocity and the direction of travel information can be utilized in post-process accuracy refinement of the prior geographic locations provided by the beacon.

### Apparatus

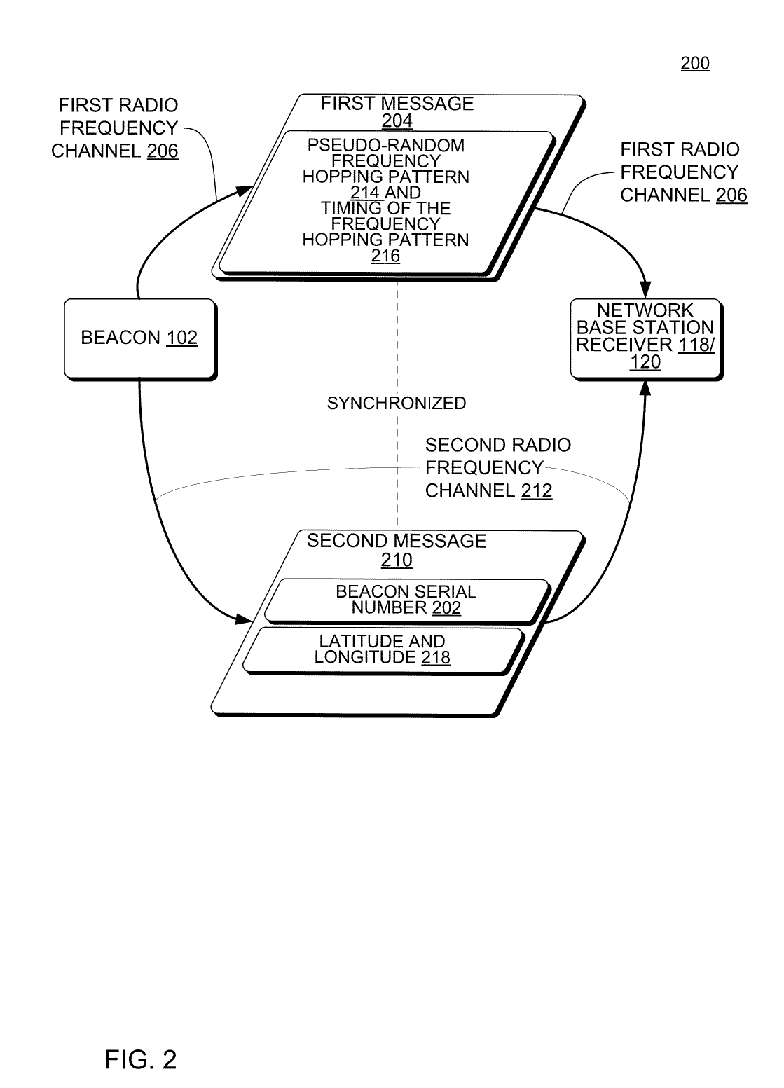

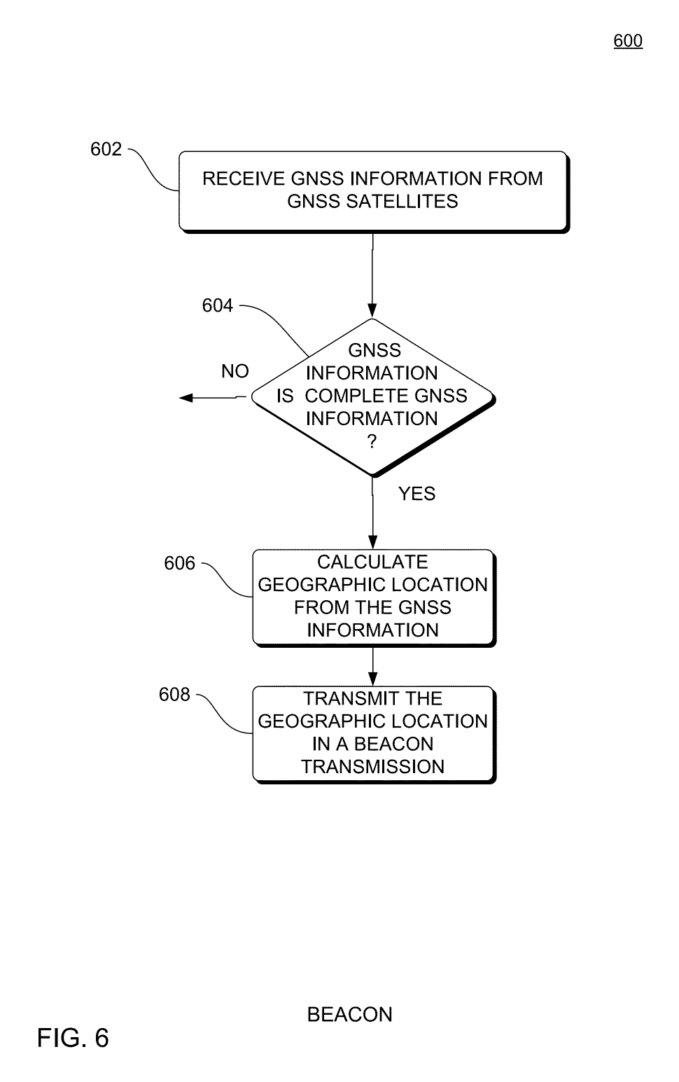

Referring to FIGS. 2-5, particular implementations are described in conjunction with the apparatus overview in FIG. 1 and the methods described in conjunction with FIGS. 6-11.

FIG. 2 is a block diagram of an overview of an apparatus 200 of wireless communication of GNSS geographic location using two messages between a beacon and a network base station receiver, according to an implementation. Apparatus 200 provides a bifurcated protocol to efficiently transmit the geographic location of the sender over radio frequencies.

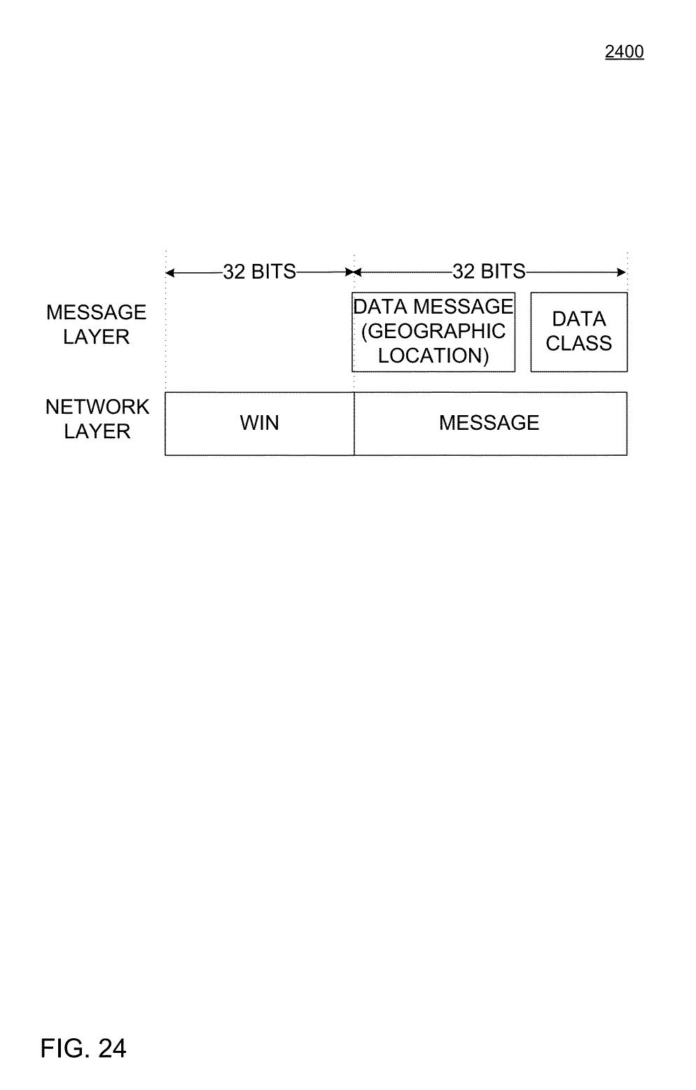

Apparatus 200 includes a beacon 102 that is capable of transmitting a first message 204 on a first radio frequency channel 206. The first message 204 provides a notice to a network base station receiver 118 or 120 of the beacon 102. The beacon 102 is also capable thereafter of transmitting a second message 210 on a second radio frequency channel 212. The first message 204 provides to the network base station receiver 118 or 120 information that is necessary for the network base station receiver 118 or 120 to grant network access to the beacon 102, such as a pseudo-random frequency hopping pattern 214 and timing 216 of the pseudo-random frequency hopping pattern. The second radio frequency channel 212 is in the pseudo-random frequency hopping pattern 214. In the implementation shown in FIG. 2-3 and FIG. 5, the second message 210 provides a latitude and longitude or other geographic location 218 of the beacon 102 as described in the detailed description of FIG. 24, or other representation of a geographic location of the beacon. In addition, the second message 210 is synchronized to the first message 204 through the pseudo-random frequency hopping pattern 214 and the timing of the pseudo-random frequency hopping pattern 216 that are referenced by both the beacon 102 and the network base station receiver 118 or 120 in the transmission of the second message 210. In one example, the pseudo-random frequency hopping pattern 214 includes 42 radio frequencies.

In apparatus 200, network access is bifurcated using two different transmissions (i.e. first message 204 and the second message 210) and two different communications channels (i.e. the first radio frequency 206 and the second radio frequency channel 212). The first message 204 provides the network with a means of detection of the beacon 102 that notifies the network of the presence of a beacon 102 and the intention of the beacon 102 to access the network. The second message 210 provides the network with a means to identify the beacon 102 and provide the geographic location 218 of the beacon 102 and to receive additional information that may be necessary to grant network access to the beacon. By transmitting a beacon serial number 202 or other identification and additional network access information in the second message 210 instead of in the first message 204, the protocol permits the duration of the first message 204 to be reduced. In the case where the network is required to provide access to a large number of beacons 102, the short duration of the first message 204 allows the number of radio frequency channels that are used to initiate network access by a beacon 102 to be reduced. The reduction in the number of radio frequency channels used to initiate network access allows the number of network base station receivers 118 or 120 to be reduced resulting in a reduction in network equipment cost and network operating cost.

The first message 204 is a short transmission that does not include a serial number of the beacon 102. A large number of beacons 102 that require infrequent network access can share a small number of network resources and can gain access to the network resources when required. The use of only a small number of network resources is achieved by minimizing the duration of the transmission of the first message 204 by the beacon 102 required to notify the network of the intention of the beacon 102 to access the network. The shorter duration of the transmission of the first message 204 allows a large number of beacons 102 to be supported with a small number of radio frequency channels. With only a small number of radio frequency channels used, the cost to deploy and operate the network is reduced. A large number of beacons 102 that require infrequent access to the network, of which the network base station receiver 118 or 120 is a part, can share a small number of network resources and can gain access to the network resources when required. The use of only a small number of network resources is achieved by minimizing the duration of the transmission of the first message 204 by the beacon 102 that is required to notify the network of the intention of the beacon 102 to access the network. The shorter duration of the transmission of the first message 204 allows a large number of beacons 102 to be supported with a small number of radio frequency channels. With only a small number of radio frequency channels used, the cost to deploy and operate the network base station receiver 118 or 120 and the network to which the network base station receiver 118 or 120 is coupled is reduced.

In some implementations, the first message 204 is transmitted four times on different radio frequency channels by the beacon 102 and the second message 210 is transmitted two times by the beacon 102 in order to ensure receipt of the first message 204 and the second message 210 under circumstances where receipt of the first message 204 and the second message 210 is not known to the beacon 102 because the network base station receiver 118 or 120 does not send an acknowledgement of the first message 204 and the second message 210. The use of acknowledgments on the first message 204 and the second message 210 will limit the capacity of the network due to the synchronization, overhead, latency, and further resource contention incurred when using acknowledgements, which is employed in conventional wireless communication networks. The transmission of the first message 204 four times and the transmission of the second message 210 two times is reasonably calculated to ensure receipt of the first message 204 and the second message 210 by the network base station receiver 118 or 120 without an excessive number of unnecessary transmissions of the first message 204 and the second message 210. The transmission of the first message 204 four times and the transmission of the second message 210 two times provides the network with frequency diversity and time diversity, where frequency and time diversity increase the probability of message reception when fading wireless communication channels are utilized and where the wireless communication channels can be further impaired by RF interference.

In some implementations, the first message 204 is transmitted based on another pseudo-random frequency hopping pattern and timing of the other pseudo-random frequency hopping pattern that are stored in both the beacon 102 and the network base station receiver 118 or 120. In one example the other pseudo-random frequency hopping pattern has twelve radio frequencies.

The first message 204 is also known as a here-i-am (HIA) transmission. The beacon 102 transmits an HIA Burst in the HIA transmission. The HIA Burst includes of four, and only four, HIA mini-bursts. Each of the HIA mini-bursts notifies the network base station receiver 118 or 120 of the presence of the beacon 102 within range of the network base station receiver 118 or 120 and notifies the network base station receiver 118 or 120 that the beacon 102 will soon transmit a REG Burst. A minimum of one network base station receiver (either network base station receiver 118 or network base station receiver 120) is required to receive at least one of the HIA mini-bursts.

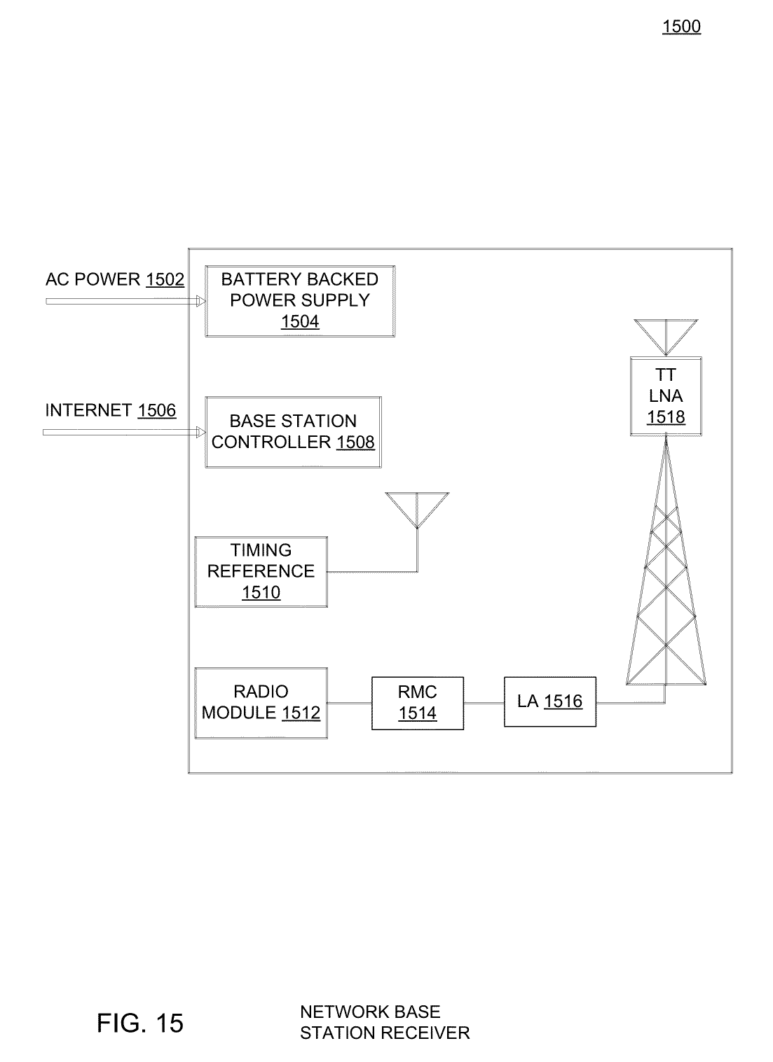

The second message 210 is also known as a registration (REG) transmission. The beacon 102 transmits a REG Burst in the REG transmission. The REG Burst includes two, and only two, REG mini-bursts. The REG mini-bursts identifies the beacon 102 by the serial number 202 of the beacon 102and notifies the network base station receiver 118 or 120 of imminent transmission by the beacon 102 of a series of SIM Bursts or no additional bursts. A minimum of one network base station receiver (either network base station receiver 118 or network base station receiver 120) is required to receive at least one of the REG mini-bursts. The serial number 202 of the beacon 102 is also known as a WIN as discussed in conjunction with FIG. 15.

While the apparatus 200 is not limited to any particular beacon 102, a first message 204, a first radio frequency channel 206, receiver 118 or 120, a second message 210, a second radio frequency channel 212 and information 214 and 216 that is necessary for the network base station receiver to grant network access to the beacon 102, for sake of clarity a simplified beacon 102, first message 204, first radio frequency channel 206, receiver 118 or 120, second message 210, second radio frequency channel 212, pseudo-random frequency hopping pattern 214 and timing 216 of the pseudo-random frequency hopping pattern are described. The network base station receiver 118 or 120 is also known as a base station.

Conventional techniques use a single transmission of a longer duration that includes both the detection and identification of the beacon 102, which requires either a larger number of communications channels to support the large number of beacons deployed in the network or restricts the number of beacons which can access the network, resulting in a higher network equipment cost and a higher network operating cost.

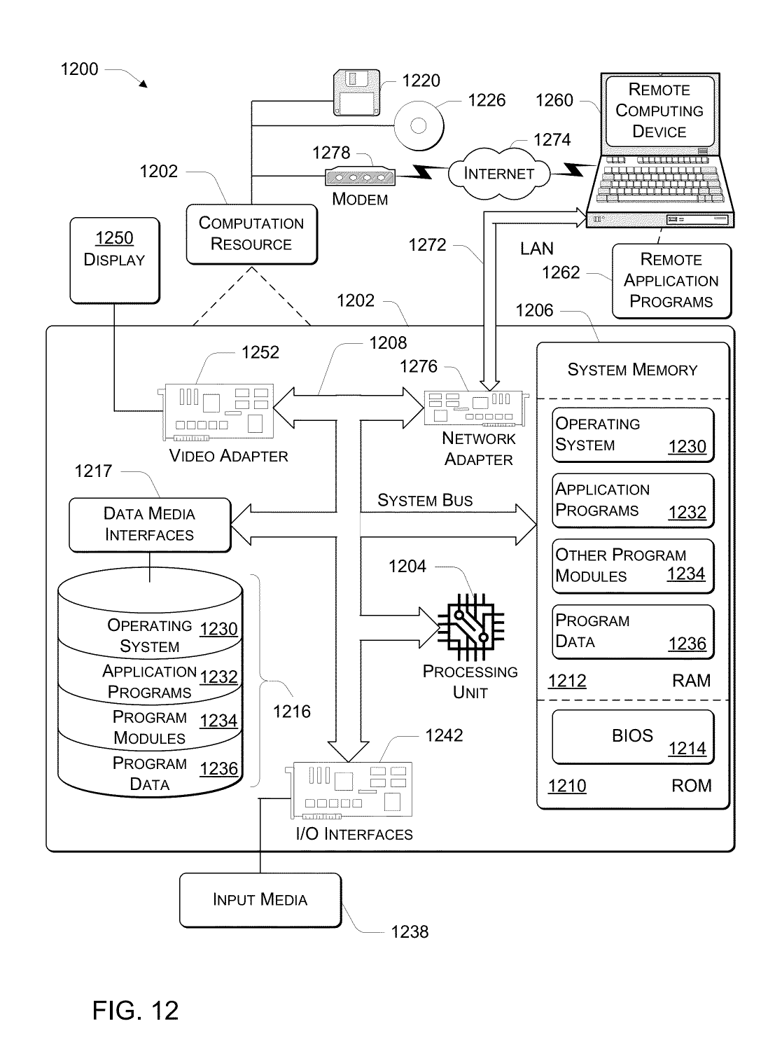

The apparatus level overview of the operation of implementations is described above in this section of the detailed description. Some implementations can operate in a multi-processing, multi-threaded operating environment on a computer, such as general computer environment 1200 in FIG. 12.

In the disclosure herein, the beacon 102 to the network base station receiver 118 or 120 are asynchronous because there is no synchronization between the beacon 102 and the network base station receiver 118 or 120. However, the transmissions between the beacon 102 and the network base station receiver 118 or 120 can be synchronized. Since there is no synchronization of the beacon 102 to the network base station receiver 208, the timing and frequency synthesis requirements of the beacon 102 allow for a lower bill of materials in the manufacturing of beacons. In addition, the inefficient transmission of downlink synchronization signals is not required by the network.

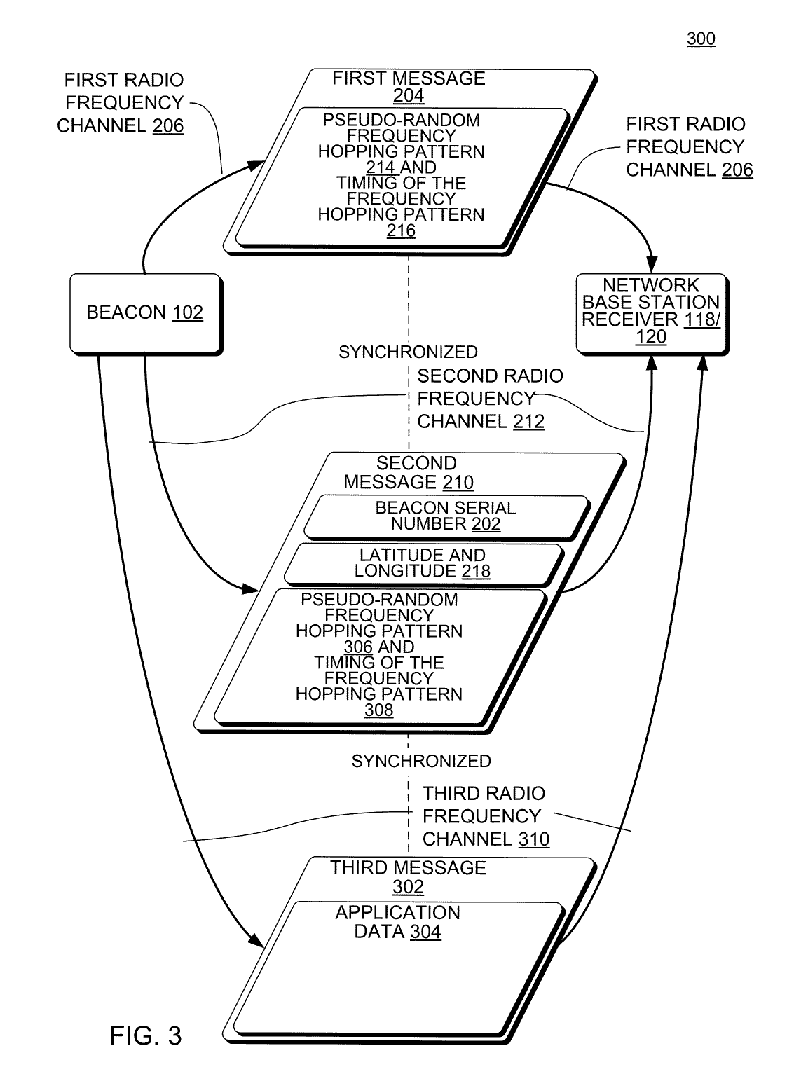

FIG. 3 is a block diagram of apparatus 300 capable of wireless telemetry communication of GNSS geographic location using three messages between a beacon and a network base station receiver, according to an implementation. In apparatus 300, the beacon 102 is operable to transmit to the network base station receiver 118 or 120 a third message 302. In the implementation shown in FIG. 3, the second message 210 includes a pseudo-random frequency hopping pattern 306 and timing 308 of the pseudo-random frequency hopping pattern. A third radio frequency channel 310 is in the pseudo-random frequency hopping pattern 306.

The third message 302 is transmitted on a third radio frequency channel 310 of the second pseudo-random frequency hopping pattern 306 and the timing 308 of the pseudo-random frequency hopping pattern, and thus the third message 302 is synchronized to the second message 210 that are referenced by both the beacon 102 and the network base station receiver 118 or 120 in the transmission of the third message 302.

The third message 302 includes data 304. In some implementations, the data 304 includes application-specific data such as remote meter reading, smart grid, intelligent traffic signs, automotive, road condition telemetry, vending machine reporting and or/road construction equipment reporting. The third message 302 does not include a serial number of the beacon 102, information representative of the radio frequencies of the pseudo-random frequency hopping patterns 214 and 306 or information representative of the timing 216 and 308 of the frequency hopping patterns 216 and 308, respectively.

Apparatus 300 provides exchange of information (i.e. data 304) from the beacon 102 to the network base station receiver 118 or 120 using a wireless communications channel (i.e. the third radio frequency channel 310) which has no conflict with the radio frequency channels (i.e. the first radio frequency channel 206 and the second radio frequency channel 212) over which communication between the beacon 102 and the network base station receiver 118 or 120 is established. The first message 204, the second message 210 and the third message 302 in the context of the protocol permits the beacon 102 to gain access to the network that the network base station receiver 118 or 120 that allows for the identification of the beacon 102 and allows for the transmission of data 304 from the beacon 102 to the network and from the network to the beacon.

In some implementations, the network base station receiver 118 or 120 is operable to transmit an acknowledgement to the beacon 102 after receiving the third message 302 and the beacon 102 is operable to attempt receipt of an acknowledgement transmission from the network base station receiver 118 or 120 after transmission of the third message 302 and the beacon 102 is operable to retransmit first message 204, the second message 210 and the third message 302 when no acknowledgement transmission by the beacon 102 from the network base station receiver 118 or 120 is received after a period of time.

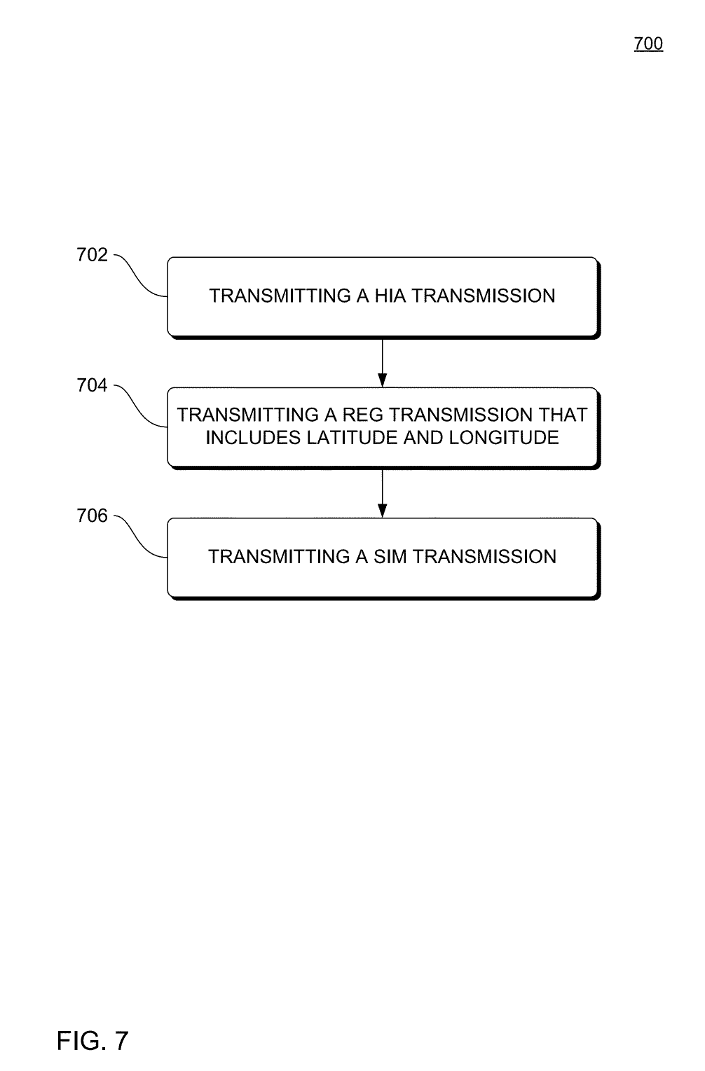

One example of the third message 302 is a SIM message that is described in at least FIGS. 7, 10, 21 and 25.

In some implementations, the beacon 102 is operable to transmit the first message 204 and the second message 210 without waiting or delaying any further operations for an acknowledgement message from the network base station receiver 118 or 120 of the first message 204 and the second message 210.

In some implementations, the first message 204 includes notice that the network base station receiver 118 or 120 is in range of the beacon 102 and the first message 204 includes a representation of imminent access by the beacon 102.

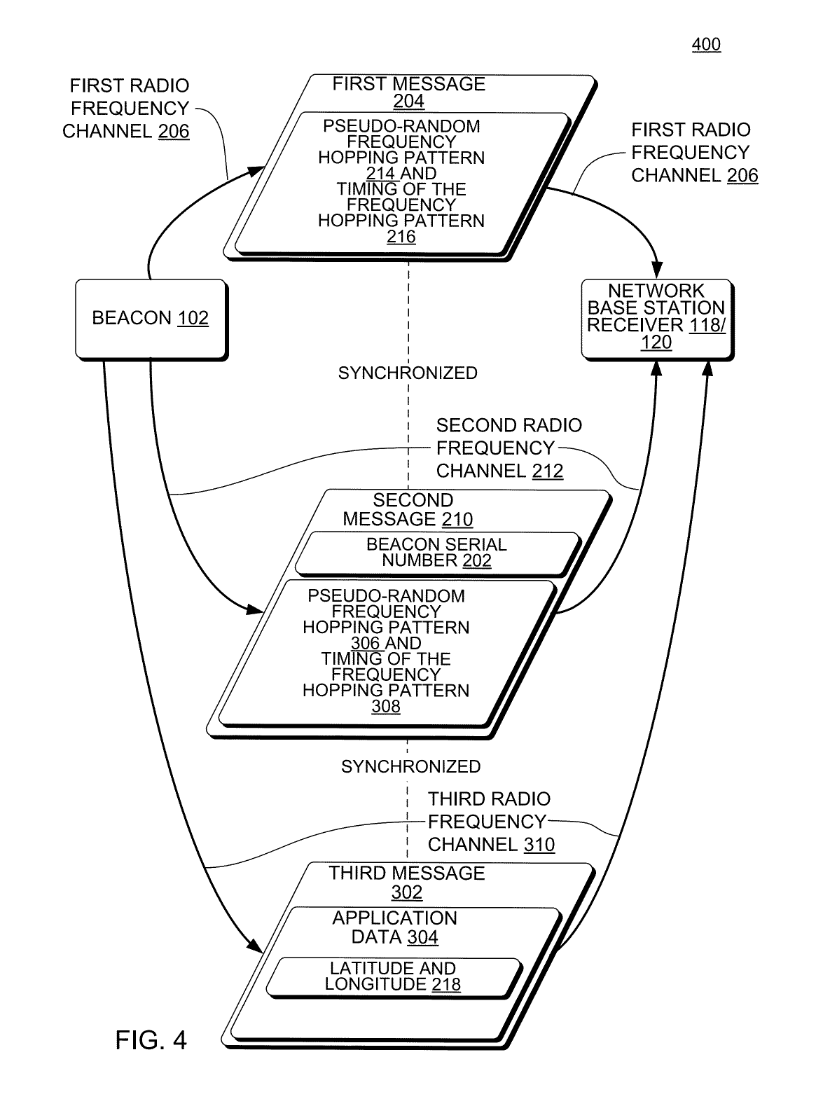

FIG. 4 is a block diagram of apparatus 400 capable of wireless telemetry communication of GNSS geographic location (latitude and longitude) using three messages between a beacon and a network base station receiver, according to an implementation. In apparatus 400, the beacon 102 is operable to transmit to the network base station receiver 118 or 120 the second message 210 having a unique identification of the beacon 102, such as a serial number 202 of the beacon 102. The beacon serial number 202 is used by the network base station receiver 118 or 120 to register the beacon as being active in the network of which the network base station receiver 118 or 120 is a part. In the implementation shown in FIG. 4, the third message 302 provides a latitude and longitude 218 of the beacon 102 as described in the detailed description of FIG. 24, or other representation of a geographic location of the beacon 102.

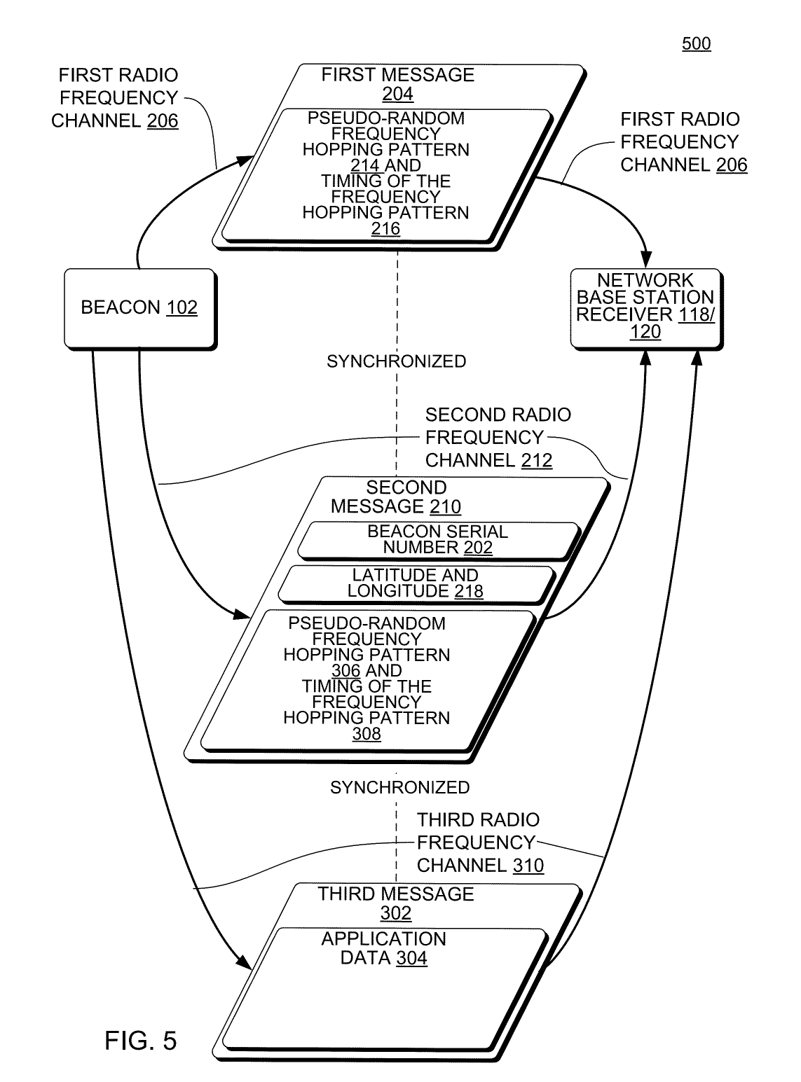

FIG. 5 is a block diagram of apparatus 500 capable of wireless telemetry communication of GNSS geographic location (latitude and longitude) using three messages between a beacon and a network base station receiver, according to an implementation. In apparatus 500, the beacon 102 is operable to transmit to the network base station receiver 118 or 120 the second message 210 having the unique identification of the beacon 102, such as the serial number 202 of the beacon 102. The beacon serial number 202 is used by the network base station receiver 118 or 120 to register the beacon 102 as being active in the network of which the network base station receiver 118 or 120 is a part. The second message 210 includes the pseudo-random frequency hopping pattern 306 and timing 308 of the pseudo-random frequency hopping pattern 306. Apparatus 500 provides a means for a large number of beacons 102 to gain network access of which the network base station receiver 118 or 120 is a part, and allows the network to receive data from the beacons 102 and to allow the beacons 102 to receive data from the network in a cost effective manner for applications that require exchange of small quantities of data 304 at a low cost. Funds received by an operator of the network from the users of the beacons 102 can be used to pay for the deployment cost of the network, the operating cost of the network and to provide a profit to the service provider.

Apparatus components of the FIG. 2-5 can be embodied as computer hardware circuitry or as a computer-readable program, or a combination of both. More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 1200 in FIG. 12, or on at least as many computers as there are components.

### Method Implementations

In the previous section, a system level overview of the operation of an implementation is described. In this section, the particular methods of such an implementation are described by reference to a series of flowcharts. Describing the methods by reference to a flowchart enables one skilled in the art to develop such programs, firmware, or hardware, including such processor-executable instructions to carry out the methods on suitable computers, executing the processor-executable instructions from computer-readable media. Similarly, the methods performed by the server computer programs, firmware, or hardware are also composed of processor-executable instructions. Methods 700-1100 can be performed by a program executing on, or performed by firmware or hardware that is a part of, a computer, such as general computer environment 1200 in FIG. 12.

FIG. 6 is a flowchart of a method 600 of a beacon receiving complete GNSS information, according to an implementation.

Method 600 includes receiving GNSS information from acquired and tracked GNSS satellites, at block 602. Thereafter, the GNSS information is analyzed to determine if the GNSS information is partial or complete GNSS information, at block 604. Complete GNSS information is adequate to estimate a geographic location of the receiving device. One example of the complete GNSS information is information from at least 3 or 4 GNSS satellites because information from 3 or 4 GNSS satellites is adequate to determine a 2D or a 3D geographic location of the receiving device, respectively. In order to obtain a 3D geographic location solution, the GNSS receiver requires acquisition and tracking of at least 4 satellites. For a 2D geographic location solution, the GNSS receiver requires acquisition and tracking of at least 3 satellites, where if only 3 satellites are being tracked then a prior altitude estimate is required. However, if an altitude estimate is not available for a possible 2D position solution when only 3 satellites are being tracked then the GNSS receiver is unable to determine a geographic location solution.

If the GNSS information is complete GNSS information, thereafter at block 606, geographic location is calculated from the complete GNSS information that was received at block 602. In some embodiments, the geographic location is calculated to a resolution of about 8 meters that requires 28 bits of storage for latitude and longitude. The geographic location 116 in FIG. 1 is obtained from the geographic location at block 606, according to an implementation. Calculating the geographic location 116 at the beacon 606 eliminates the processing load of calculating the beacon's geographic location 116 on the network manager operations center 124 and/or on the beacon tracker 126, furthermore it takes advantage of availability of processor resources on the beacon 102 to calculate or determine the geographic location 116. In some implementations, the geographic location is selected from a group of geographic location in a geographical coordinate system consisting of a stationary 2-dimensional geographic location, a stationary 3-dimensional geographic location, a kinematic 2-dimensional geographic location and a kinematic 3-dimensional geographic location.

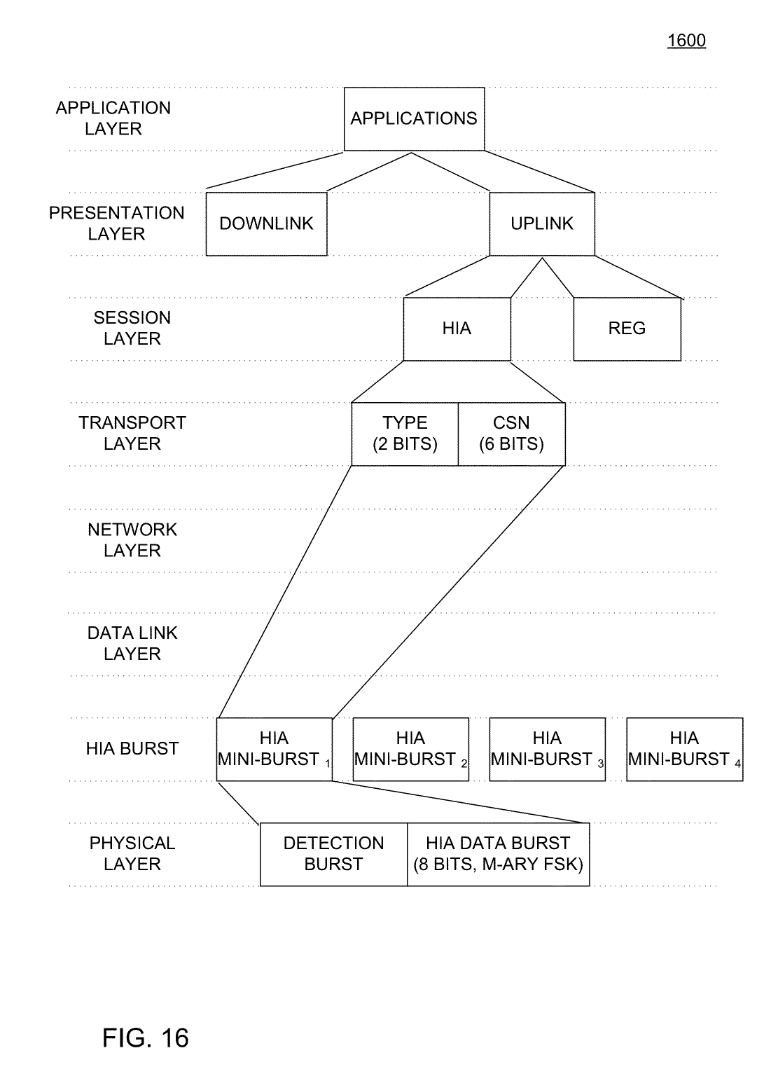

The geographic location is transmitted in a beacon transmission, at block 608. Examples of the beacon transmission are first message 204, second message 210, third message 302 and the here-i-am (HIA), registration (REG) and short-and-instant telemetry messaging (SIM) transmissions described in FIG. 16-FIG. 25. In one example, the geographic location is transmitted in the 28 bit “Data Message” portion of the message layer of a REG transmission, as shown in FIG. 24 and the “Data Class” portion of the message layer of the REG transmission is set to a 4 bit value that represents an indication of complete GNSS information of the geographic location. In another example, the geographic location is transmitted in a SIM transmission.

FIG. 7 is a flowchart of a method 700 of wireless telemetry communication from a beacon to a network base station receiver, according to an implementation.

Method 700 includes transmitting a here-i-am (HIA) transmission from a beacon to a network base station receiver, at block 702. The HIA transmission is the first message 204 in FIG. 2. In some embodiments, the transmission is performed on a radio frequency channel of 12 radio frequency channels in which the 12 radio frequency channels are identified in a first pseudo-random frequency hopping pattern. In some implementations of block 702, the HIA transmission provides notice that the beacon is in range of the network base station receiver, provides a representation of imminent access to the network base station receiver and provides a notice that the beacon will transmit a registration (REG) transmission to the network base station receiver and the HIA transmission includes a second pseudo-random frequency hopping pattern, such as 214 in FIG. 2, and a timing of the second pseudo-random frequency hopping pattern, such as 216 in FIG. 2.

Method 700 includes transmitting the REG transmission that includes a geographic location, at block 704. The REG transmission is transmitted on one of the radio frequency channels in the second pseudo-random frequency hopping pattern, thus the REG transmission is synchronized to the HIA transmission on the second pseudo-random frequency hopping pattern. The REG transmission includes a serial number of beacon and a third pseudo-random frequency hopping pattern, such as 306 in FIG. 3, the geographic location 116, and a timing of the third pseudo-random frequency hopping pattern, such as 308 in FIG. 3.

Method 700 includes transmitting a short-and-instant telemetry messaging (SIM) transmission, at block 706. The SIM transmission is transmitted on one of the radio frequency channels in the third pseudo-random frequency hopping pattern, thus the SIM transmission is synchronized to the REG transmission on the third pseudo-random frequency hopping pattern. The SIM transmission includes data, the data including application-specific data such as remote meter reading, smart grid, intelligent traffic signs, automotive, road condition telemetry, vending machine reporting, road construction equipment reporting, the data not including the serial number of the beacon. The data does not include the information representative of the timing and information representative of any of the pseudo-random frequency hopping patterns.

The radio frequency channels of the first, second and third pseudo-random frequency hopping patterns are mutually exclusive.

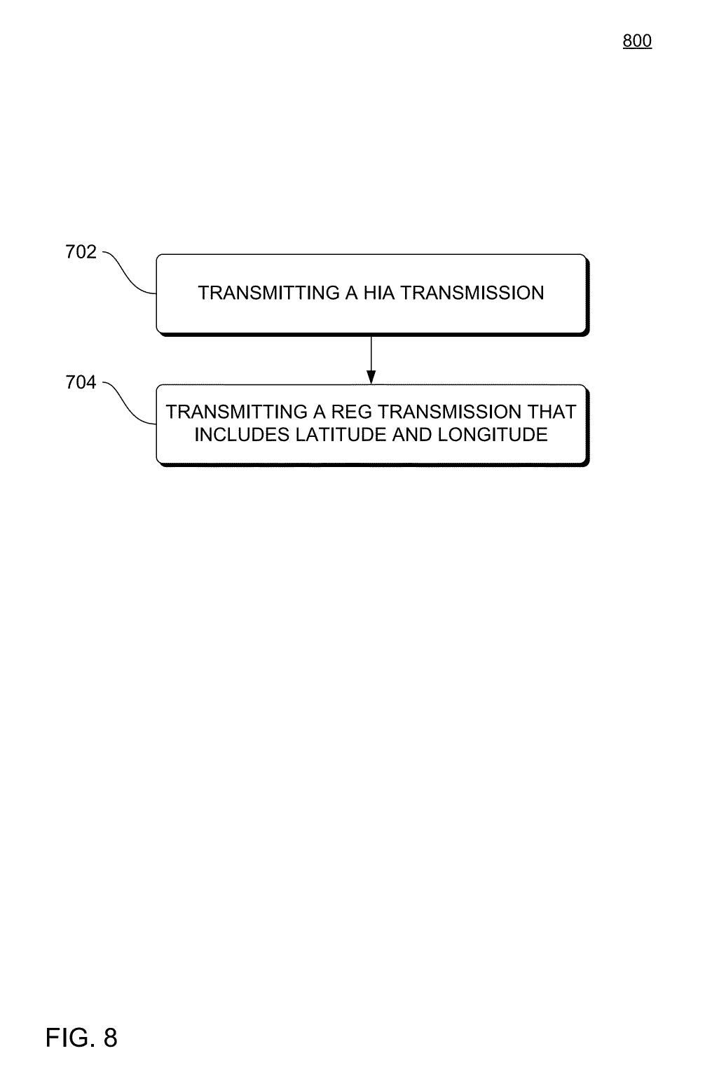

FIG. 8 is a flowchart of a method 800 of wireless geographic location tracking communication from a beacon to a network base station receiver, according to an implementation.

Method 800 includes transmitting a here-i-am (HIA) transmission from a beacon to a network base station receiver, at block 702.

Method 800 includes transmitting the registration (REG) transmission that includes a latitude and longitude, at block 704.

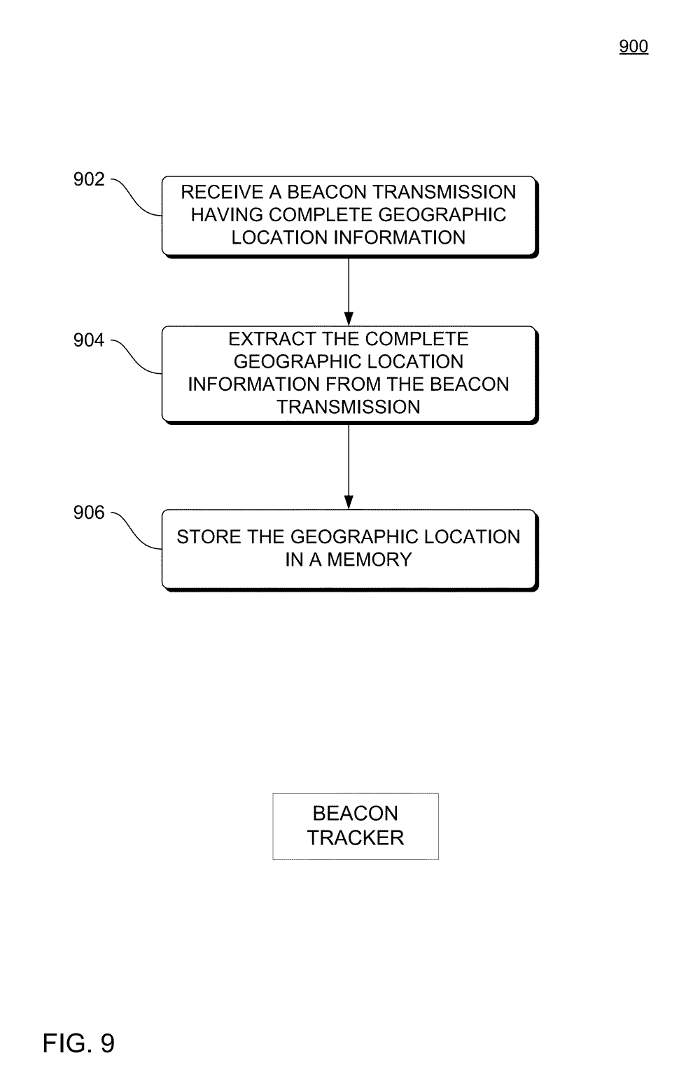

FIG. 9 is a flowchart of a method 900 of a beacon tracker locating a beacon from complete GNSS information in a beacon transmission, according to an implementation. Beacon tracker 126 in FIG. 1 is one example of the beacon tracker operable to perform method 900.

Method 900 includes receiving one or more beacon transmission(s) that include complete GNSS information, at block 902. Examples of the beacon transmission(s) are first message 204, second message 210, third message 302 in FIG. 2-5 and the here-i-am (HIA), registration (REG) and short-and-instant telemetry messaging (SIM) transmissions described in FIG. 16-FIG. 25. In one example, the geographic location is a latitude and longitude and the latitude and longitude is transmitted in a 28 bit “Data Message” portion of the message layer of a REG transmission, as shown in FIG. 24 and the “Data Class” portion of the message layer of the REG transmission is set to a 4 bit value that represents an indication of complete GNSS information of the latitude and longitude. In another example, the latitude and longitude is transmitted in a SIM transmission as shown in FIG. 4.

Method 900 also includes extracting the complete GNSS information from the one or more beacon transmission(s) as the estimated geographic location when the transmission(s) indicate that complete GNSS information is in the transmission(s), at block 904. Some implementations of method 900 also include storing the beacon geographic location in a memory, at block 906, to be available for use by application programs.

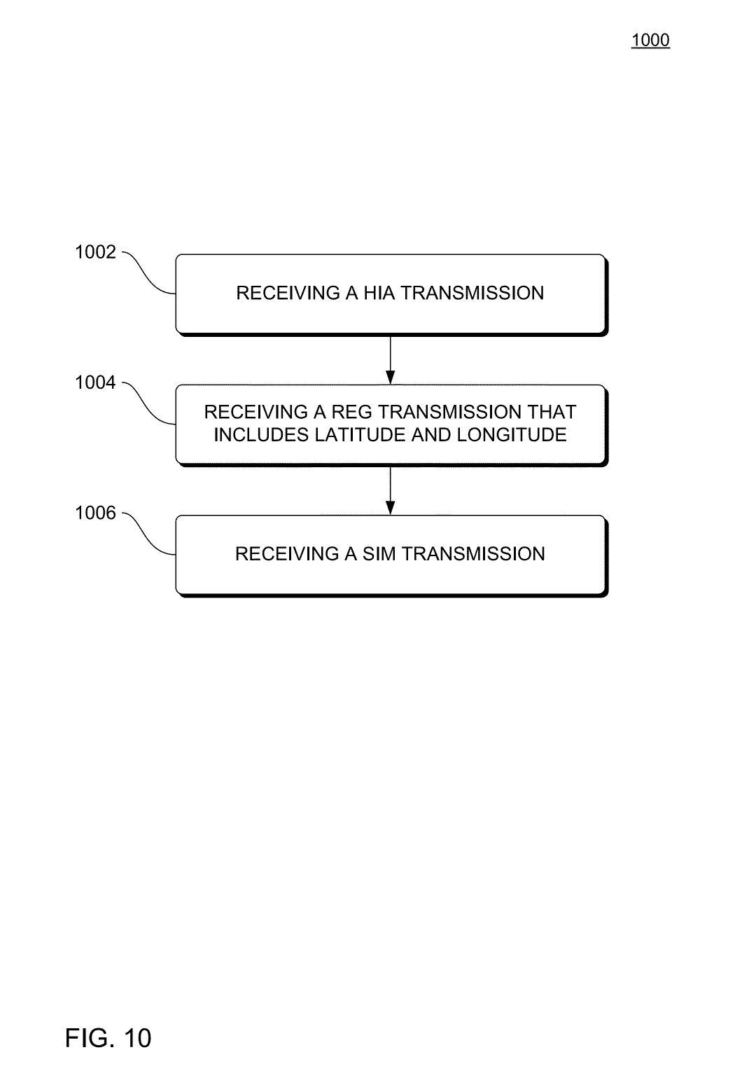

FIG. 10 is a flowchart of a method 1000 of wireless telemetry communication at a network base station receiver, according to an implementation.

Method 1000 includes receiving a here-i-am (HIA) transmission at a network base station receiver, at block 1002. The HIA transmission is the first message 204 in FIG. 2. In some embodiments, the transmission is received on a radio frequency channel of 12 radio frequency channels in which the 12 radio frequency channels are identified in a first pseudo-random frequency hopping pattern. The HIA transmission is interpreted as providing notice that the beacon is in range of the network base station receiver, providing notice a representation of imminent access to the network base station receiver and providing notice that the beacon will transmit a registration (REG) transmission to the network base station receiver. The HIA transmission includes a second pseudo-random frequency hopping pattern, such as 214 in FIG. 2, and a timing of the second pseudo-random frequency hopping pattern, such as 216 in FIG. 2. The HIA transmission is a short transmission that does not include a serial number of the beacon.

Method 1000 includes receiving the REG transmission that includes a geographic location, at block 1004. The REG transmission is received on one of the radio frequency channels in the second pseudo-random frequency hopping pattern, thus the REG transmission is synchronized to the HIA transmission on the second pseudo-random frequency hopping pattern. The REG transmission includes a serial number of beacon and a third pseudo-random frequency hopping pattern, such as 306 in FIG. 3, and a timing of the third pseudo-random frequency hopping pattern, such as 308 in FIG. 3.

Method 1000 includes receiving a short-and-instant telemetry messaging (SIM) transmission, at block 1006. The SIM transmission is received on one of the radio frequency channels in the third pseudo-random frequency hopping pattern, thus the SIM transmission is synchronized to the REG transmission on the third pseudo-random frequency hopping pattern. The SIM transmission includes data, the data including application-specific data such as remote meter reading, smart grid, intelligent traffic signs, automotive, road condition telemetry, vending machine reporting, road construction equipment reporting, the data not including the serial number of the beacon. The data does not include the information representative of the timing and information representative of any of the pseudo-random frequency hopping patterns.

The radio frequency channels of the first, second and third pseudo-random frequency hopping patterns are mutually exclusive.

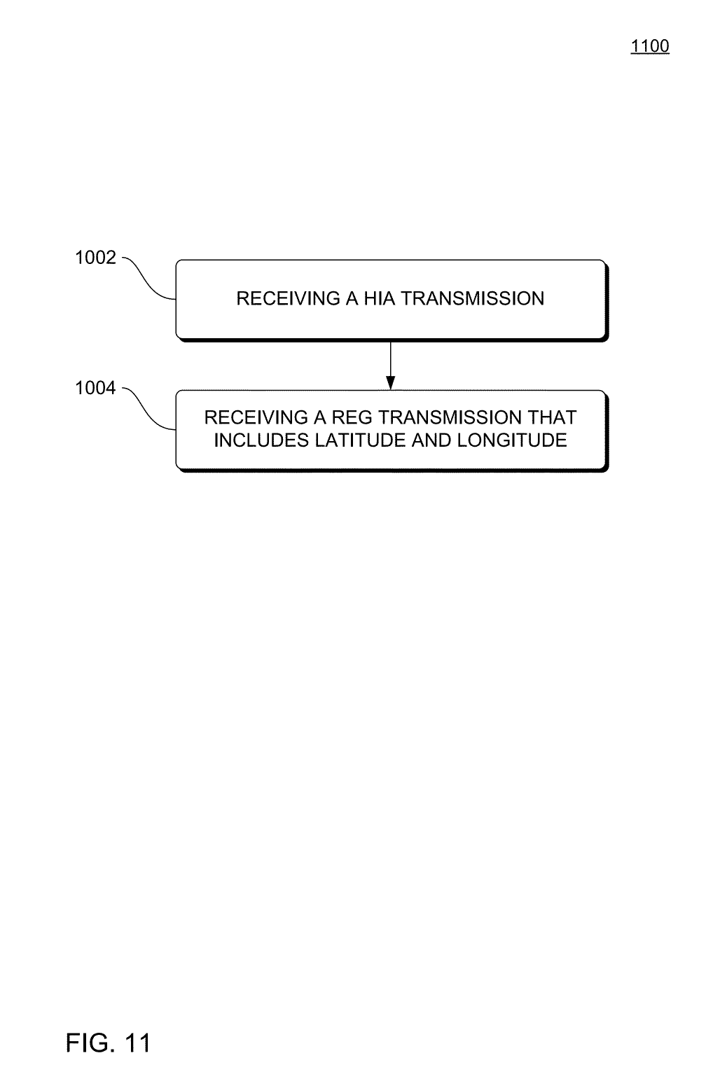

FIG. 11 is a flowchart of a method 1100 of wireless geographic location tracking communication at a network base station receiver, according to an implementation. Method 1100 includes receiving a here-i-am (HIA) transmission at a network base station receiver, at block 1002. Method 1100 includes receiving the REG transmission that includes a geographic location, at block 1004.

In some implementations, methods 600-1100 are implemented as a computer data signal embodied in a carrier wave, that represents a sequence of processor-executable instructions which, when executed by a processor, such as processing units 1204 in FIG. 12, cause the processor to perform the respective method. In other implementations, methods 800-1100 are implemented as a computer-accessible medium having processor-executable instructions capable of directing a processor, such as processing units 1204 in FIG. 12, to perform the respective method. In varying implementations, the medium is a magnetic medium, an electronic medium, or an optical medium. In some implementations, the computer-accessible medium includes multiple computer-accessible mediums, either located on a common printed circuit board (PCB), or on multiple PCBs.

### Hardware and Operating Environment

FIG. 12 is a block diagram of a hardware and operating environment 1200 in which different implementations can be practiced. The description of FIG. 12 provides an overview of computer hardware and a suitable computing environment in conjunction with which some implementations can be implemented. Implementations are described in terms of a computer executing processor-executable instructions. However, some implementations can be implemented entirely in computer hardware in which the processor-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 12 illustrates an example of a general computer environment 1200 useful in the context of FIG. 1-11, according to an implementation. The general computer environment 1200 includes a computation resource 1202 capable of implementing the processes described herein. It will be appreciated that other devices can alternatively be used that include more components, or fewer components, than those illustrated in FIG. 12.

The illustrated operating environment 1200 is only one example of a suitable operating environment, and the example described with reference to FIG. 12 is not intended to suggest any limitation as to the scope of use or functionality of the implementations of this disclosure. Other well-known computing systems, environments, and/or configurations can be suitable for implementation and/or application of the subject matter disclosed herein.

The computation resource 1202 includes one or more processors or processing units 1204, a system memory 1206, and a bus 1208 that couples various system components including the system memory 1206 to processor(s) 1204 and other elements in the environment 1200. The bus 1208 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 1206 includes nonvolatile read-only memory (ROM) 1210 and random access memory (RAM) 1212, which can or cannot include volatile memory elements. A basic input/output system (BIOS) 1214, containing the elementary routines that help to transfer information between elements within computation resource 1202 and with external items, typically invoked into operating memory during start-up, is stored in ROM 1210.

The computation resource 1202 further can include a non-volatile read/write memory 1216, represented in FIG. 12 as a hard disk drive, coupled to bus 1208 via a data media interface 1217 (e.g., a SCSI, ATA, or other type of interface); a magnetic disk drive (not shown) for reading from, and/or writing to, a removable magnetic disk 1220 and an optical disk drive (not shown) for reading from, and/or writing to, a removable optical disk 1226 such as a CD, DVD, or other optical media.

The non-volatile read/write memory 1216 and associated computer-readable media provide nonvolatile storage of processor-readable instructions, data structures, program modules and other data for the computation resource 1202. Although the exemplary environment 1200 is described herein as employing a non-volatile read/write memory 1216, a removable magnetic disk 1220 and a removable optical disk 1226, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 1216, magnetic disk 1220, optical disk 1226, ROM 1210, or RAM 1212, including an operating system 1230, one or more application programs 1232, other program modules 1234 and program data 1236. Examples of computer operating systems conventionally employed for some types of three-dimensional and/or two-dimensional medical image data include the NUCLEUS® operating system, the LINUX® operating system, and others, for example, providing capability for supporting application programs 1232 using, for example, code modules written in the C++® computer programming language.

A user can enter commands and information into computation resource 1202 through input devices such as input media 1238 (e.g., keyboard/keypad, tactile input or pointing device, mouse, foot-operated switching apparatus, joystick, touchscreen or touchpad, microphone, antenna etc.). Such input devices 1238 are coupled to the processing unit 1204 through a conventional input/output interface 1242 that is, in turn, coupled to the system bus. A monitor 1250 or other type of display device is also coupled to the system bus 1208 via an interface, such as a video adapter 1252.

The computation resource 1202 can include capability for operating in a networked environment using logical connections to one or more remote computers, such as a remote computer 1260. The remote computer 1260 can be a personal computer, a server, a router, a network PC, a peer device or other common network node, and typically includes many or all of the elements described above relative to the computation resource 1202. In a networked environment, program modules depicted relative to the computation resource 1202, or portions thereof, can be stored in a remote memory storage device such as can be associated with the remote computer 1260. By way of example, remote application programs 1262 reside on a memory device of the remote computer 1260. The logical connections represented in FIG. 12 can include interface capabilities, a storage area network (SAN, not illustrated in FIG. 12), local area network (LAN) 1272 and/or a wide area network (WAN) 1274, but can also include other networks.

Such networking environments are commonplace in modern computer systems, and in association with intranets and the Internet. In certain implementations, the computation resource 1202 executes an Internet Web browser program (which can optionally be integrated into the operating system 1230), such as the “Internet Explorer®” Web browser manufactured and distributed by the Microsoft Corporation of Redmond, Wash.

When used in a LAN-coupled environment, the computation resource 1202 communicates with or through the local area network 1272 via a network interface or adapter 1276. When used in a WAN-coupled environment, the computation resource 1202 typically includes interfaces, such as a modem 1278, or other apparatus, for establishing communications with or through the WAN 1274, such as the Internet. The modem 1278, which can be internal or external, is coupled to the system bus 1208 via a serial port interface.

In a networked environment, program modules depicted relative to the computation resource 1202, or portions thereof, can be stored in remote memory apparatus. It will be appreciated that the network connections shown are exemplary, and other means of establishing a communications link between various computer systems and elements can be used.

A user of a computer can operate in a networked environment using logical connections to one or more remote computers, such as a remote computer 1260, which can be a personal computer, a server, a router, a network PC, a peer device or other common network node. Typically, a remote computer 1260 includes many or all of the elements described above relative to the computer 1200 of FIG. 12.

The computation resource 1202 typically includes at least some form of computer-readable media. Computer-readable media can be any available media that can be accessed by the computation resource 1202. By way of example, and not limitation, computer-readable media can comprise computer storage media and communication media.

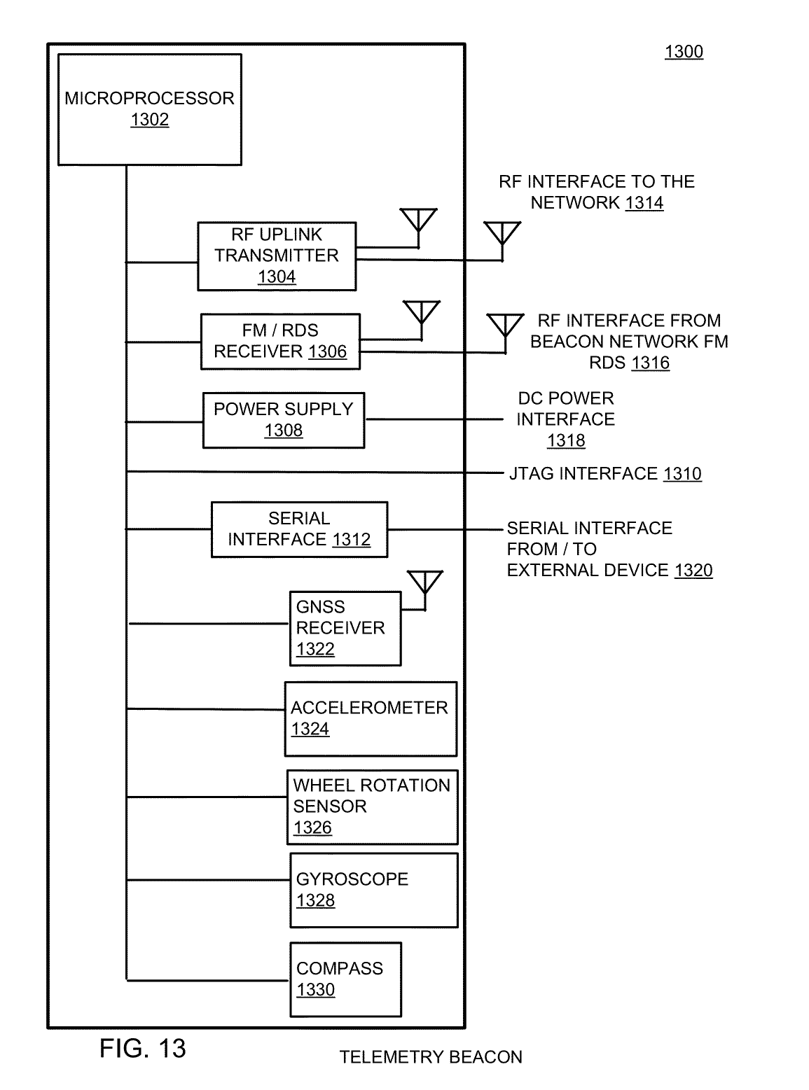

FIG. 13 is a block diagram of a telemetry beacon hardware environment 1300, according to an implementation. The telemetry beacon hardware environment 1300 is one example of beacon 102 and can perform method 700 in FIG. 7 and method 800 in FIG. 8. The telemetry beacon hardware environment 1300 includes a microprocessor 1302 that is operably coupled to a radio frequency (RF) uplink transmitter 1304, a FM/RDS receiver 1306, a power supply 1308, a JTAG interface 1310, a serial interface 1312 and a GNSS receiver 1322. The RF uplink transmitter 1304 provides an RF interface 1314 to the network (not shown in FIG. 13.). The FM/RDS receiver 1306 provides an RF interface from a beacon network RM RDS (not shown in FIG. 13). The power supply 1308 is operably coupled to a DC power interface 1318. The serial interface 1312 is operably coupled to a serial interface 1320 from/to an external device (not shown in FIG. 13). The telemetry beacon hardware environment 1300 includes one or more receivers or sensors of external geographic location reference, such as a GNSS receiver 1322 that receives GNSS signal, such as GNSS signals 104, 106 and 108. The GNSS receiver 1322 acquires and tracks at least one GNSS satellite such as 110, 112 and 114 in FIG. 1. The acquisition includes determining which satellites are visible to a GNSS antenna, determining the approximate Doppler of each visible satellite, search for the signal in both pseudo-random noise (PRN) code delay and frequency (i.e., Doppler shift, satellite clock offset and receiver clock offset) and detect a signal and determine its PRN code delay, carrier frequency, satellite clock offset and receiver clock offset. Tracking the GNSS signals includes tracking changes in the PRN code delay and carrier frequency. Other examples of receivers or sensors of external geographic location reference include an accelerometer 1324, a wheel rotation sensor 1326, a gyroscope 1328 and/or a digital compass 1330 as known to those of ordinary skill in the art. In other implementations, one or more of the receivers or sensors of external geographic location reference, such as a GNSS receiver 1322, and located externally, in close proximity and operably coupled to the telemetry beacon hardware environment 1300.

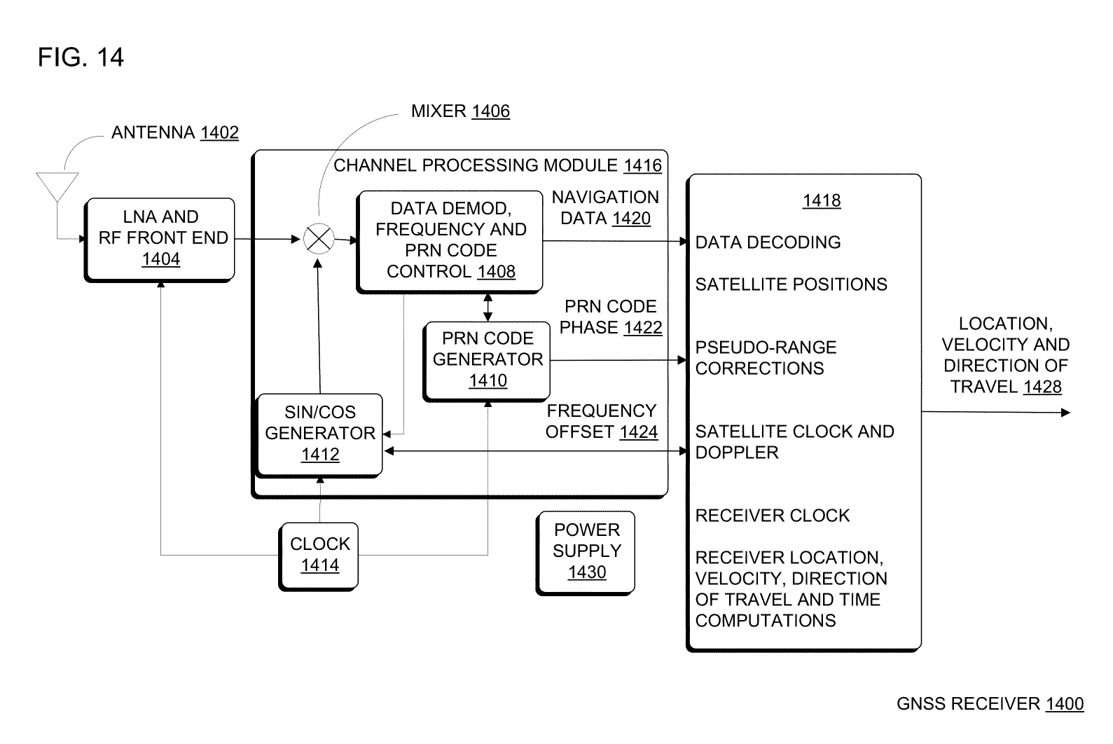

FIG. 14 is a simplified block diagram of a GNSS receiver hardware environment 1400, according to an implementation. The GNSS receiver hardware environment 1400 is one example of the GNSS receiver 1322 in FIG. 13. The GNSS receiver hardware environment 1400 includes an antenna 1402 that receives GNSS signals from GNSS satellites (such as 110, 112 and 114 in FIG. 1) as an input and outputs the signals to a low-noise amplifier (LNA) and RF Front End 1404, which is comprised of filter(s), a frequency synthesizer, a frequency down converter, a analog gain control (AGC) and analog-to-digital conversion. The LNA and RF Front End 1404 outputs downconverted and digitized GNSS signals to the input of a mixer 1406 which is subsequently sent to the input of the data demodulator, frequency and PRN code control unit 1408. The data demodulator, frequency and PRN code control unit 1408 controls the pseudo-random noise (PRN) code generator 1410 and the sinusoid/cosinusoid (SIN/COS) generator 1412. The PRN code is sent to the input of the data demodulator, frequency and PRN code control unit 1408, which is comprised of a correlation function, and acquisition and tracking loops for both the residual GNSS satellite carrier frequency and the GNSS satellite PRN code. The mixer 1406, data demodulator, frequency and PRN code control unit 1408, PRN code generator 1410 and SIN/COS generator 1412 encompass a GNSS satellite receiver channel processing module 1416, which is utilized to acquire, track and process a single GNSS satellite signal. A GNSS satellite receiver has several GNSS satellite receiver channel processing modules 1416 in order to acquire, track and process multiple GNSS satellite signals. The data demodulator, frequency and PRN code control unit 1408 transmits a navigation data 1420 to a controller unit 1418. The PRN code generator 1410 transmits a PRN code phase 1422 to the controller unit 1418. The SIN/COS generator 1412 transmits the satellite frequency offset 1424 to the controller unit 1418. The controller unit 1418 transmits location, velocity and direction of travel 1428.

FIG. 15 is a block diagram of a network base station receiver hardware environment 1500, according to an implementation. The network base station receiver hardware environment 1500 is one example of network base station receiver 118 or 120 and can perform method 1000 in FIG. 10 and method 1100 in FIG. 11. The network base station receiver hardware environment 1500 receives alternating current power 1502 into a battery backed power supply 1504. The network base station receiver hardware environment 1500 receives data from the Internet 1506 to a base station controller 1508 and transmits data from the base station controller 1508 to the network over the internet 1506 or over some other suitable wired or wireless communication link. The network base station receiver hardware environment 1500 also includes a timing reference component 1510. The network base station receiver hardware environment 1500 also includes a radio module 1512 that is operably coupled to a receiver multicoupler (RMC) 1514, that is operably coupled to a lightning arrestor (LA) 1516, that is operably coupled to tower-top low-noise amplifier (TT LNA) 1518.

Computer storage media include volatile and nonvolatile, removable and non-removable media, implemented in any method or technology for storage of information, such as processor-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 1202.

Communication media typically embodies processor-executable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

### Implementations of the Protocols

Various implementations of the protocols are described without limiting this disclosure.

### HIA Burst

Each HIA Burst indicates an upcoming transmission of a REG Burst. Each HIA Burst includes of four HIA mini-bursts. Each HIA mini-burst includes of two parts, a Detection Burst followed by a HIA Data Burst. The Detection Burst is used by the network to detect the beginning of the HIA mini-burst. The HIA Data Burst contains 8 data bits: two bits are used to determine the Type of mini-burst: HIA (00b) while the remaining 6 bits are used to transmit the Channel Sequence number (CSN).

Regardless of the Type of mini-burst that is utilized by the HIA, the selection of the channels is pseudo-random. The HIA channel number in combination with the Channel Sequence Number is used to identify which of the mini-bursts has been received. This information is used to determine the time at which the REG Burst may be received. The Channel Sequence Number is used to determine the REG mini-burst channel hopping pattern.

### HIA Mini-Burst

Each of the four HIA mini-bursts is transmitted sequentially with a 38.0 ms delay measured from the beginning of one HIA mini-burst to the beginning of the next HIA mini-burst. Each HIA mini-burst includes of two parts, a Detection Burst of 16.384 ms duration followed by one HIA Data Burst of 16.384 ms duration. The beginning of the first HIA mini-burst is referred to as HIA Sync Time.

FIG. 16 is a diagram of protocol stack layers for a HIA Burst 1600, according to an implementation. FIG. 16 shows the protocol layers of the uplink HIA Burst used in a message 204, the beacon application beginning an uplink transmission sequence with an HIA Burst, the HIA Burst containing the required information, Type and CSN, each HIA Burst comprised of four HIA mini-bursts, the required information encoded into the HIA mini-burst in the desired modulation format for transmission with the Detection Burst, according to an implementation.

### REG Burst

The beacon 102 transmits a REG Burst. The REG Burst includes two REG mini-bursts. Each of the two mini-bursts are transmitted sequentially with a fixed delay measured from the beginning of the first mini-burst to the beginning of the second mini-burst. The selection of the REG channels is pseudo-random.

The network base station receiver 1500 assigns radio receivers, as necessary, to tune to the required registration channel at the required time to receive one or both of the REG mini-bursts. While the REG mini-burst is longer in duration than the HIA mini-burst, the required number of deployed radio receivers is reduced by the fact that the channels are only monitored on an as-needed basis.

### REG Mini-Burst

Each REG mini-burst includes REG Data Burst that contains the following encoded information:

| | | |
|---|---|---|
| 1. | WIN | 32 bits |
| 2. | Data Message | 28 bits |
| 3. | Data Class | 4 bits |
| 4. | CRC check character | 8 bits |
| | Total | 72 bits |

The beacon 102 Identification Number (WIN) uniquely identifies the transmitting beacon 102. The network base station receiver 118 or 120 uses the WIN to interpret the identity and application of the transmitting beacon 102. No two beacons 102 have the same WIN. The WIN is also known as the beacon serial number 202 in FIG. 2-5.

The Data Message component is used for application specific data and is defined by the application and by the Data Class. The Data Class (4 bit field) defines how the bits in the Data Message are interpreted. Several Data Classes have been developed to support fleet, vehicle recovery and telemetry client applications, according to an implementation.

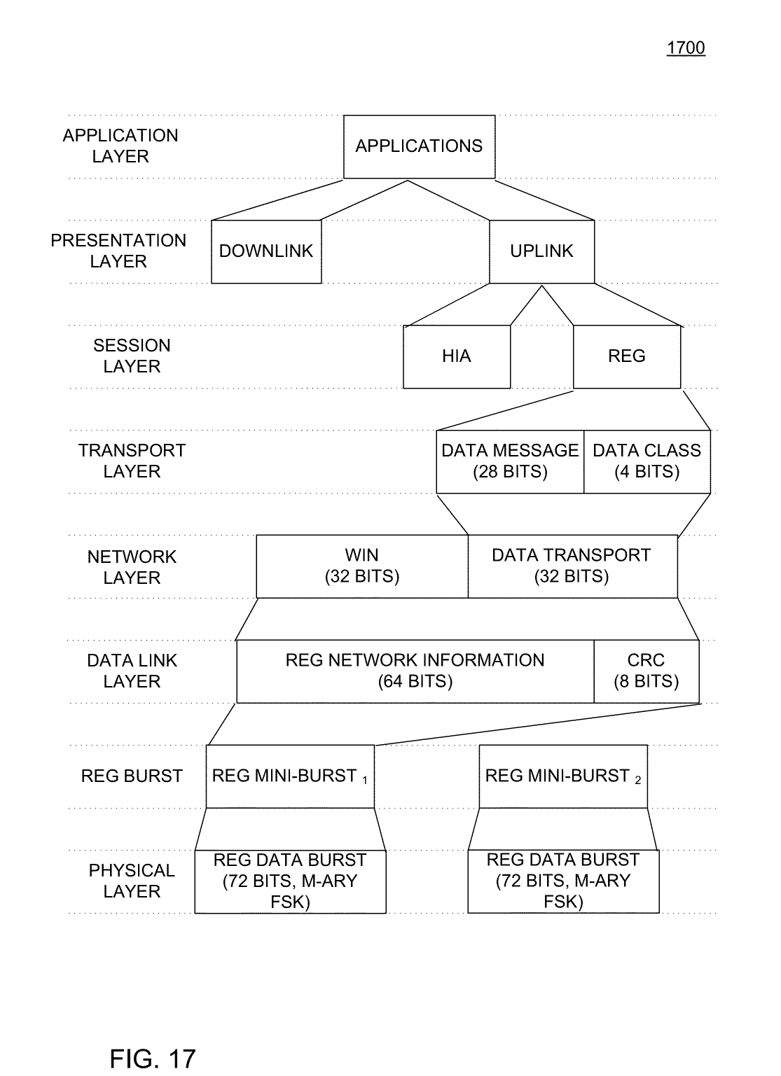

FIG. 17 is a diagram of protocol stack layers for a REG Burst 1700, according to an implementation. FIG. 17 shows the protocol layers of the uplink REG Burst used in a message 210, the beacon application beginning an uplink transmission sequence with an HIA Burst, followed by a REG Burst, the REG Burst containing the required information, WIN, Data Message, Data Class and cyclic redundancy check (CRC), each REG Burst comprised of two REG mini-bursts, the required information encoded into the REG mini-burst in the desired modulation format for transmission, according to an implementation.

### SIM

The SIM uplink transmission is able to carry a telemetry uplink message from the beacon to the network. The data are partitioned into 9-byte non-overlapping blocks for encapsulation into SIM Bursts. If the length of the data, in bytes, is not an integer multiple of 9, then a sufficient number of bytes with a value of 0x00 are appended at the end.

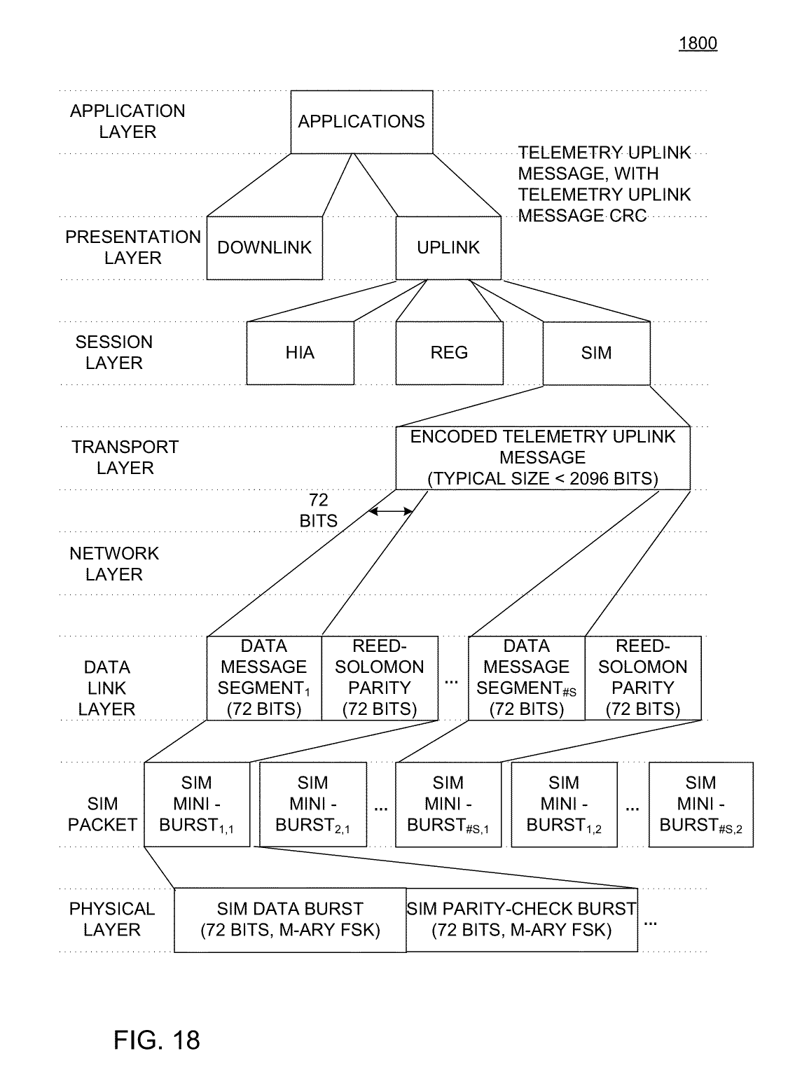

Next, each 9-byte block is Reed-Solomon encoded, to form a SIM Burst. Aggregating all of the SIM Bursts together forms a SIM Packet as shown in FIG. 18.

### SIM Packet

FIG. 18 is a diagram of protocol stack layers of a SIM Packet 1800, according to an implementation. Each SIM Packet includes of as many SIM Bursts as necessary to transmit the data as shown in FIG. 18.

FIG. 18 shows the protocol layers of the uplink SIM Packet used in a message 302, the beacon application beginning an uplink transmission sequence with an HIA Burst, followed by a REG Burst, followed by a SIM Packet, the SIM Packet comprised of the encoded telemetry uplink message, the SIM Packet comprised of #S SIM Bursts where each SIM Burst consists of a segment of the encoded telemetry uplink message with Reed-Solomon encoding, the SIM Burst comprising of two SIM mini-bursts which are encoded into the desired modulation formation for transmission according to an implementation.

### SIM Burst

Each SIM Burst includes two SIM mini-bursts.

### SIM Transmission Timing

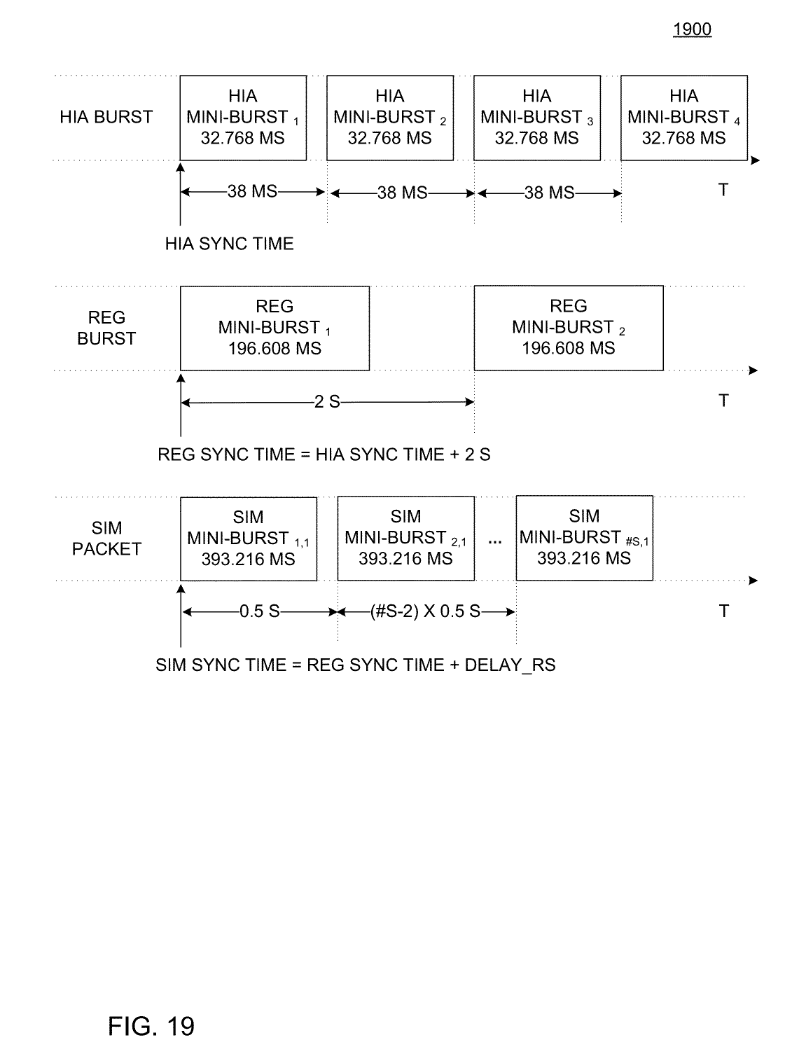

The transmission sequence and timing for a SIM Packet are described as follows (all delays measured from start of preceding SIM mini-burst to start of next SIM mini-burst). The timing and synchronization reference points of the SIM mini-bursts are shown in FIG. 19.
SIM Sync Time: Transmit SIM mini-burst_{1,1} of duration 393.216 ms
delay 0.5 seconds
Transmit SIM mini-burst_{2,1} of duration 393.216 ms
delay 0.5 seconds
. . . continue transmission of all the SIM mini-bursts_{i,1} (i=3, 4, . . . , #S) and their corresponding delays
Transmit SIM mini-burst_{i,2} of duration 393.216 ms
delay 0.5 seconds
. . . Transmit SIM mini-burst_{2,2} of duration 393.216 ms
delay 0.5 seconds
. . . continue transmission of all the SIM mini-bursts_{i,2} (i=3, 4, . . . , #S) and their corresponding delays
where SIM mini-bursts_{i,1} denotes the first SIM mini-burst of the i^{th} SIM Burst, i.e. SIM Burst, and SIM mini-bursts_{i,2} denotes the second SIM mini-burst of the i^{th} SIM Burst.

### Air Interface—Physical to Logical Channel Mapping

In order to increase the utilization of the bandwidth available in the 2400 MHz ISM band, the HIA, REG and SIM channels are allocated a bandwidth of 62.5 kHz each. The channels are allocated at a minimum channel spacing of 31.25 kHz and carefully chosen to allow the channels to be interleaved. Due to the bandwidth of the HIA, REG, and SIM signals and the allowable variations in carrier frequency the HIA, REG and SIM signals can fall outside of the allocated channels.

Some of the channels located near the 2400 MHz band edge and some of the channels located near the 2483.5 MHz band edge are left unused to serve as a guard band to assist in the compliance with the radio transmitter regulations. Leaving a 937.5 kHz guard band on the lower band edge of the 2400 MHz ISM band and a 1000 kHz guard band on the upper band edge, and designating the lowest possible channel as 1, we have the following center frequencies:

f_{RF}=2400.9375 MHz+N(0.03125 MHz) Equation 1

Where:

N=[1, . . . , 2639] Equation 2

The distribution of these channels among the different logical channels are as follows:

12 HIA channels,

42 REG channels (paired in groups of two),

84 SIM channels (paired in groups of two),

123 Reserved channels.

### HIA Transmission

The 12 HIA channels have been divided into four groups of three HIA channels each. The groups are known as HIA group A, HIA group B, HIA group C, and HIA group D. The HIA channels are designated HIA channel A₁, A₂, A₃, B₁, B₂, B₃, C₁, C₂, C₃, D₁, D₂ and D₃.

When the beacon 102 transmits the four consecutive HIA mini-bursts, each one of the four HIA mini-bursts are transmitted on a different HIA channel group (either group A, B, C, or D), where the order of the groups and the channel number within the group are pseudo-randomly selected. The network base station receiver 118 or 120 network continuously monitors the HIA channels and receives the HIA mini-bursts. By decoding the Channel Sequence Number within the HIA mini-burst and knowing the channel group on which the HIA mini-burst was received the Network is able to determine which of the four HIA mini-bursts was received (first, second, third or fourth). By knowing the transmission time of the HIA mini-bursts and by knowing which of the four HIA was received (first, second, third or fourth), the time of the Registration Burst can be determined. By decoding the Channel Sequence Number within the HIA mini-burst, the channel number for each of the Registration mini-bursts can be determined.

### HIA Channel Sequence

The HIA channels are used in such a manner that the HIA mini-bursts are uniformly distributed among the 12 HIA channels. The HIA transmission channel sequence conforms to the following requirements.

Each HIA Burst uses one channel from each of the HIA channel groups (i.e. the four HIA mini-bursts uses one channel from group A, one channel from group B, one channel from group C and one channel from group D).

The order in which the channel groups are used are pseudo-randomly selected and change from one HIA Burst to the next.

The channel number within each group follows a pseudo-random sequence based upon the WIN of the beacon 102. Each channel number of each channel group are used in any group of three consecutive REG (i.e. the pattern repeats every 12 HIA transmissions).

The CSN are initialized according to the formula given in Equation 3. The Channel Sequence Number (CSN) is incremented for each HIA Burst by a simple linear congruent generator (LCG), which is of the format CSNᵢ₊₁=(a×CSNᵢ+b) mod 64. The LCG coefficients “a” and “b” are assigned from the 6 LSBs of the WIN from a predetermined lookup table, and the initial CSN value (i.e. CSN₀); or seed, are determined by Equation. 3 on power-up.

CSN₀={WIN_{H} ⊕[(WIN_{L} & 0x0FFF)<<1]}mod₆₄ Equation 3

Where {WIN_{H}, WIN_{L}} denote the upper and lower 16 bits of the WIN respectively, & denotes the bit-wise and operator, ⊕ denotes the bit-wise exclusive-or operator, and <<n denotes an n-bit shift to the left (i.e. multiplication by 2ⁿ).

The beacon 102 can transmit an uplink transmission sequence that allows the beacon to either register with the network manager operations center 124 and/or allow the beacon to transmit a short data message to the network manager operations center 124 without the network requiring the geographic location 116 of the beacon 102 or receiving a SIM telemetry message 302. This uplink message sequence is referred to as a No LOC/No SIM (NLNS) sequence and should not interfere with the timing and synchronization of a current uplink transmission sequence and/or downlink communication activities, therefore, it is assigned its own Channel Sequence Number CSN_{NLNS}. The CSN_{NLNS} are initialized according to the formula given in Equation 3. The CSN_{NLNS} are incremented for each No LOC/No SIM transmission sequence by using the assigned LCG.

### HIA Channel Numbers

The 12 channels reserved for HIA have been carefully chosen so as to minimize the effects of interference and to maximize system availability. The HIA channel numbers and frequencies are as follows in Table 1.

TABLE 1
HIA Channel Frequencies
Sorted by HIA channel designator

| | | Center | | | Center |
|---|---|---|---|---|---|
| HIA | Channel | Frequency | HIA | Channel | Frequency |
| Channel | Number | (MHz) | Channel | Number | (MHz) |
| A₁ | 295 | 2410.15625 | C₁ | 1555 | 2449.53125 |
| A₂ | 1135 | 2436.40625 | C₂ | 1975 | 2462.65625 |
| A₃ | 1765 | 2456.09375 | C₃ | 2395 | 2475.78125 |
| B₁ | 85 | 2403.59375 | D₁ | 715 | 2423.28125 |
| B₂ | 505 | 2416.71875 | D₂ | 1345 | 2442.96875 |
| B₃ | 925 | 2429.84375 | D₃ | 2185 | 2469.21875 |

Sorted by channel frequency

| | | Center | | | Center |
|---|---|---|---|---|---|
| HIA | Channel | Frequency | HIA | Channel | Frequency |
| Channel | Number | (MHz) | Channel | Number | (MHz) |
| B₁ | 85 | 2403.59375 | D₂ | 1345 | 2442.96875 |
| A₁ | 295 | 2410.15625 | C₁ | 1555 | 2449.53125 |
| B₂ | 505 | 2416.71875 | A₃ | 1765 | 2456.09375 |
| D₁ | 715 | 2423.28125 | C₂ | 1975 | 2462.65625 |
| B₃ | 925 | 2429.84375 | D₃ | 2185 | 2469.21875 |
| A₂ | 1135 | 2436.40625 | C₃ | 2395 | 2475.78125 |

The following relations give the center frequency of the HIA channels based upon the subscript index k.

f_{HIA}(Aₖ)=[77125+210×[3(k−1)+└k>>1┘]]×31250

f_{HIA}(Bₖ)=[76495+420k]×31250

f_{HIA}(Cₖ)=[77965+420k]×31250

f_{HIA}(Dₖ)=[77545+210×[4(k−1)−└k>>1┘]]×31250 Equation 4

Where └ ┘ denotes integer truncation; i.e. rounding down to the nearest integer value, and >>n denotes an n-bit shift to the right (i.e. multiplication by 2⁻ⁿ).

### REG Transmission

When the beacon 102 transmits a REG Burst, the beacon 102 will always transmit two identical mini-bursts. Each of the two REG transmissions are transmitted on a different REG channel. The network base station receiver 118 or 120 uses the timing information and channel information obtained from any one of the four HIA mini-bursts to tune a portion of the Network to the specified channel at the specified time in order to receive one of the two REG mini-bursts. In the event that the Network fails to receive the first REG mini-burst transmission, the Network can repeat the process and attempt to receive the second REG mini-burst. Each REG mini-burst contains the WIN.

### REG Channel Sequence

The channels used are selected such that a large number of beacons 102 use the REG channels in such a manner that the REG mini-bursts are uniformly distributed among the 42 REG channels. The REG transmission channel sequence conforms to the following requirements.

Each REG mini-burst of a REG Burst uses a different REG channel.

The REG channel patterns are selected based upon the CSN (or CSN_{NLNS}), where the CSN sequence is determined by the assigned LCG.

### REG Channel Numbers

In Table 2 below, the 42 channels reserved for REG have been carefully chosen so as to minimize the effects of interference and to maximize system availability. The REG channel numbers and frequencies are as follows:

TABLE 2
REG Channel Frequencies

| | | Center |
|---|---|---|
| REG | Channel | Frequency |
| Channel | Number | (MHz) |
| R₁ | 87 | 2403.65625 |
| R₂ | 147 | 2405.53125 |
| R₃ | 207 | 2407.40625 |
| R₄ | 267 | 2409.28125 |
| R₅ | 327 | 2411.15625 |
| R₆ | 387 | 2413.03125 |
| R₇ | 447 | 2414.90625 |
| R₈ | 507 | 2416.78125 |
| R₉ | 567 | 2418.65625 |
| R₁₀ | 627 | 2420.53125 |
| R₁₁ | 687 | 2422.40625 |
| R₁₂ | 747 | 2424.28125 |
| R₁₃ | 807 | 2426.15625 |
| R₁₄ | 867 | 2428.03125 |
| R₁₅ | 927 | 2429.90625 |
| R₁₆ | 987 | 2431.78125 |
| R₁₇ | 1047 | 2433.65625 |
| R₁₈ | 1107 | 2435.53125 |
| R₁₉ | 1167 | 2437.40625 |
| R₂₀ | 1227 | 2439.28125 |
| R₂₁ | 1287 | 2441.15625 |
| R₂₂ | 1347 | 2443.03125 |
| R₂₃ | 1407 | 2444.90625 |
| R₂₄ | 1467 | 2446.78125 |
| R₂₅ | 1527 | 2448.65625 |
| R₂₆ | 1587 | 2450.53125 |
| R₂₇ | 1647 | 2452.40625 |
| R₂₈ | 1707 | 2454.28125 |
| R₂₉ | 1767 | 2456.15625 |
| R₃₀ | 1827 | 2458.03125 |
| R₃₁ | 1887 | 2459.90625 |
| R₃₂ | 1947 | 2461.78125 |
| R₃₃ | 2007 | 2463.65625 |
| R₃₄ | 2067 | 2465.53125 |
| R₃₅ | 2127 | 2467.40625 |
| R₃₆ | 2187 | 2469.28125 |
| R₃₇ | 2247 | 2471.15625 |
| R₃₈ | 2307 | 2473.03125 |
| R₃₉ | 2367 | 2474.90625 |
| R₄₀ | 2427 | 2476.78125 |
| R₄₁ | 2487 | 2478.65625 |
| R₄₂ | 2547 | 2480.53125 |

The following equation determines the center frequency for the REG channels based upon the subscript index k of Table 2.

f_{REG}(Rₖ)=[76857+60k]×31250 Equation 5

### SIM Channel Sequence

The channels used are selected such that a large number of beacons 102 use the SIM channels in such a manner that the SIM mini-bursts are uniformly distributed among the SIM channels.

### SIM Channel Numbers

There are 84 channels for use by SIM. These channels have been chosen so as to reduce the effects of interference and to improve system availability. The channels used by SIM are listed in Table 3.

The following equation determines the center frequency for the SIM channels based upon the subscript index k of Table 3.

f_{SIM}(Mₖ)=[76889+30k]×31250 Equation 6

TABLE 3
SIM Channel Frequencies

| | | Center |
|---|---|---|
| SIM | Channel | Frequency |
| Channel | Number | (MHz) |
| M₁ | 89 | 2403.71875 |
| M₂ | 119 | 2404.65625 |
| M₃ | 149 | 2405.59375 |
| M₄ | 179 | 2406.53125 |
| M₅ | 209 | 2407.46875 |
| M₆ | 239 | 2408.40625 |
| M₇ | 269 | 2409.34375 |
| M₈ | 299 | 2410.28125 |
| M₉ | 329 | 2411.21875 |
| M₁₀ | 359 | 2412.15625 |
| M₁₁ | 389 | 2413.09375 |
| M₁₂ | 419 | 2414.03125 |
| M₁₃ | 449 | 2414.96875 |
| M₁₄ | 479 | 2415.90625 |
| M₁₅ | 509 | 2416.84375 |
| M₁₆ | 539 | 2417.78125 |
| M₁₇ | 569 | 2418.71875 |
| M₁₈ | 599 | 2419.65625 |
| M₁₉ | 629 | 2420.59375 |
| M₂₀ | 659 | 2421.53125 |
| M₂₁ | 689 | 2422.46875 |
| M₂₂ | 719 | 2423.40625 |
| M₂₃ | 749 | 2424.34375 |
| M₂₄ | 779 | 2425.28125 |
| M₂₅ | 809 | 2426.21875 |
| M₂₆ | 839 | 2427.15625 |
| M₂₇ | 869 | 2428.09375 |
| M₂₈ | 899 | 2429.03125 |
| M₂₉ | 929 | 2429.96875 |
| M₃₀ | 959 | 2430.90625 |
| M₃₁ | 989 | 2431.84375 |
| M₃₂ | 1019 | 2432.78125 |
| M₃₃ | 1049 | 2433.71875 |
| M₃₄ | 1079 | 2434.65625 |
| M₃₅ | 1109 | 2435.59375 |
| M₃₆ | 1139 | 2436.53125 |
| M₃₇ | 1169 | 2437.46875 |
| M₃₈ | 1199 | 2438.40625 |
| M₃₉ | 1229 | 2439.34375 |
| M₄₀ | 1259 | 2440.28125 |
| M₄₁ | 1289 | 2441.21875 |
| M₄₂ | 1319 | 2442.15625 |
| M₄₃ | 1349 | 2443.09375 |
| M₄₄ | 1379 | 2444.03125 |
| M₄₅ | 1409 | 2444.96875 |
| M₄₆ | 1439 | 2445.90625 |
| M₄₇ | 1469 | 2446.84375 |
| M₄₈ | 1499 | 2447.78125 |
| M₄₉ | 1529 | 2448.71875 |
| M₅₀ | 1559 | 2449.65625 |
| M₅₁ | 1589 | 2450.59375 |
| M₅₂ | 1619 | 2451.53125 |
| M₅₃ | 1649 | 2452.46875 |
| M₅₄ | 1679 | 2453.40625 |
| M₅₅ | 1709 | 2454.34375 |
| M₅₆ | 1739 | 2455.28125 |
| M₅₇ | 1769 | 2456.21875 |
| M₅₈ | 1799 | 2457.15625 |
| M₅₉ | 1829 | 2458.09375 |
| M₆₀ | 1859 | 2459.03125 |
| M₆₁ | 1889 | 2459.96875 |
| M₆₂ | 1919 | 2460.90625 |
| M₆₃ | 1949 | 2461.84375 |
| M₆₄ | 1979 | 2462.78125 |
| M₆₅ | 2009 | 2463.71875 |
| M₆₆ | 2039 | 2464.65625 |
| M₆₇ | 2069 | 2465.59375 |
| M₆₈ | 2099 | 2466.53125 |
| M₆₉ | 2129 | 2467.46875 |
| M₇₀ | 2159 | 2468.40625 |
| M₇₁ | 2189 | 2469.34375 |
| M₇₂ | 2219 | 2470.28125 |
| M₇₃ | 2249 | 2471.21875 |
| M₇₄ | 2279 | 2472.15625 |
| M₇₅ | 2309 | 2473.09375 |
| M₇₆ | 2339 | 2474.03125 |
| M₇₇ | 2369 | 2474.96875 |
| M₇₈ | 2399 | 2475.90625 |
| M₇₉ | 2429 | 2476.84375 |
| M₈₀ | 2459 | 2477.78125 |
| M₈₁ | 2489 | 2478.71875 |
| M₈₂ | 2519 | 2479.65625 |
| M₈₃ | 2549 | 2480.59375 |
| M₈₄ | 2579 | 2481.53125 |

### HIA Mini-Burst Frequency Hopping Pattern

The sub-channels in the HIA groupings {A, B, C, D} have a period of three, which ensures that each of the frequencies of each individual sub-group is transmitted in any three consecutive REG periods. This restricts the randomness of the selection of sub-channels selected per group in any time interval. i.e. binomial coefficient

$$( \begin{matrix}3 \\ 1\end{matrix} )$$

per group {A, B, C, D} in the first registration interval, then

$$( \begin{matrix}2 \\ 1\end{matrix} )$$

for the second interval, and

$$( \begin{matrix}1 \\ 1\end{matrix} )$$

for the third interval.

For example, for HIA group A, we can start from the set {1, 2, 3}. If 3 is selected for the first interval, then on the next interval we are restricted to the set {1, 2} for HIA A. If 1 is then selected, then for the third interval we must use 2 for HIA A. Thus, the HIA A pattern becomes {A₃, A₁, A₂}.

The HIA grouping pattern based on the CSN conforms to Table 4, which contains the HIA and REG channel sequences for the corresponding Channel Sequence Number.

The HIA sub-channel selection can only generate two possible sequences, i.e. {1, 2, 3, 1, . . . } and {1, 3, 2, 1, . . . }. Therefore, sequence {1, 2, 3, . . . } and {1, 3, 2, . . . } are denoted as HIA sub-sequence 0 and 1 respectively.

For HIA groups {A, B, C, D}, the corresponding sub-sequence are determined by bits {W(9), W(10), W(11), W(12)} of the 32-bit WIN, where W(0) represents the least significant bit (LSB) of the WIN. The HIA sub-sequences can easily be generated in the following manner.

$${y}_{k + 1} + 1 = \{ \begin{matrix}( {y}_{k} + 1 ) {mod}_{3} + 1 , for WIN {bit}_{i} = 0 \\ ( {y}_{k} + 2 ) {mod}_{3} + 1 , for WIN {bit}_{i} = 1\end{matrix} \qquad Equation 7$$

The initial or starting seed for each HIA sequence are determined upon power-up of the beacon 102, where the 8 LSBs are paired in the following method.

$${y}_{0} + 1 = \{ \begin{matrix}[ W ( 1 ) W ( 0 ) ] {mod}_{3} + 1 , for HIA group A \\ [ W ( 3 ) W ( 2 ) ] {mod}_{3} + 1 , for HIA group B \\ [ W ( 5 ) W ( 4 ) ] {mod}_{3} + 1 , for HIA group C \\ [ W ( 7 ) W ( 6 ) ] {mod}_{3} + 1 , for HIA group D\end{matrix} \qquad Equation 8$$

For example, let WIN=5695785=0x0056 E929.

The 8 LSBs of the WIN are b#0010 1001, thus, the initial seed of the HIA groups {A, B, C, D} are y₀+1={2, 3, 3, 1} respectively. Similarly, {W(9), W(10), W(11), W(12)}={0, 0, 1, 0}. Therefore, HIA groups {A, B, C, D} will use sub-sequences {0, 0, 1, 0} respectively.

Thus, the consecutive sub channel numbering per HIA group upon power-up is then as follows:

| k | Aₖ | Bₖ | Cₖ | Dₖ |
|---|---|---|---|---|
| 0 | 2 | 3 | 3 | 1 |
| 1 | 3 | 1 | 2 | 2 |
| 2 | 1 | 2 | 1 | 3 |
| 3 | 2 | 3 | 3 | 1 |
| 4 | 3 | 1 | 2 | 2 |

TABLE 4
CSN to HIA group mapping

| | HIA |
|---|---|
| CSN | Group |
| 0 | A, B, C, D |
| 1 | A, B, D, C |
| 2 | A, C, B, D |
| 3 | A, C, D, B |
| 4 | A, D, B, C |
| 5 | A, D, C, B |
| 6 | B, A, C, D |
| 7 | B, A, D, C |
| 8 | B, C, A, D |
| 9 | B, C, D, A |
| 10 | B, D, A, C |
| 11 | B, D, C, A |
| 12 | C, A, B, D |
| 13 | C, A, D, B |
| 14 | C, B, A, D |
| 15 | C, B, D, A |
| 16 | C, D, A, B |
| 17 | C, D, B, A |
| 18 | D, A, B, C |
| 19 | D, A, C, B |
| 20 | D, B, A, C |
| 21 | D, B, C, A |
| 22 | D, C, A, B |
| 23 | D, C, B, A |
| 24 | A, B, C, D |
| 25 | A, B, D, C |
| 26 | A, C, B, D |
| 27 | A, C, D, B |
| 28 | A, D, B, C |
| 29 | A, D, C, B |
| 30 | B, A, C, D |
| 31 | B, A, D, C |
| 32 | B, C, A, D |
| 33 | B, C, D, A |
| 34 | B, D, A, C |
| 35 | B, D, C, A |
| 36 | C, A, B, D |
| 37 | C, A, D, B |
| 38 | C, B, A, D |
| 39 | C, B, D, A |
| 40 | C, D, A, B |
| 41 | C, D, B, A |
| 42 | D, A, B, C |
| 43 | D, A, C, B |
| 44 | D, B, A, C |
| 45 | D, B, C, A |
| 46 | D, C, A, B |
| 47 | D, C, B, A |
| 48 | A, B, C, D |
| 49 | A, B, D, C |
| 50 | A, C, B, D |
| 51 | A, C, D, B |
| 52 | A, D, B, C |
| 53 | A, D, C, B |
| 54 | B, A, C, D |
| 55 | B, A, D, C |
| 56 | B, C, A, D |
| 57 | B, C, D, A |
| 58 | B, D, A, C |
| 59 | B, D, C, A |
| 60 | C, A, B, D |
| 61 | C, A, D, B |
| 62 | C, B, A, D |
| 63 | C, B, D, A |

### REG Channel Frequency Hopping Pattern

TABLE 5
CSN to REG channel mapping

| | Paired REG |
|---|---|
| CSN | Channels |
| 0 | R₁, R₈ |
| 1 | R₂, R₉ |
| 2 | R₃, R₁₀ |
| 3 | R₄, R₁₁ |
| 4 | R₅, R₁₂ |
| 5 | R₆, R₁₃ |
| 6 | R₇, R₁₄ |
| 7 | R₈, R₁₅ |
| 8 | R₉, R₁₆ |
| 9 | R₁₀, R₁₇ |
| 10 | R₁₁, R₁₈ |
| 11 | R₁₂, R₁₉ |
| 12 | R₁₃, R₂₀ |
| 13 | R₁₄, R₂₁ |
| 14 | R₁₅, R₂₂ |
| 15 | R₁₆, R₂₃ |
| 16 | R₁₇, R₂₄ |
| 17 | R₁₈, R₂₅ |
| 18 | R₁₉, R₂₆ |
| 19 | R₂₀, R₂₇ |
| 20 | R₂₁, R₂₈ |
| 21 | R₂₂, R₂₉ |
| 22 | R₂₃, R₃₀ |
| 23 | R₂₄, R₃₁ |
| 24 | R₂₅, R₃₂ |
| 25 | R₂₆, R₃₃ |
| 26 | R₂₇, R₃₄ |
| 27 | R₂₈, R₃₅ |
| 28 | R₂₉, R₃₆ |
| 29 | R₃₀, R₃₇ |
| 30 | R₃₁, R₃₈ |
| 31 | R₃₂, R₃₉ |
| 32 | R₃₃, R₄₀ |
| 33 | R₃₄, R₄₁ |
| 34 | R₃₅, R₄₂ |
| 35 | R₃₆, R₁ |
| 36 | R₃₇, R₂ |
| 37 | R₃₈, R₃ |
| 38 | R₃₉, R₄ |
| 39 | R₄₀, R₅ |
| 40 | R₄₁, R₆ |
| 41 | R₄₂, R₇ |
| 42 | R₁₅, R₂₈ |
| 43 | R₁₆, R₂₉ |
| 44 | R₁₇, R₃₀ |
| 45 | R₁₈, R₃₁ |
| 46 | R₁₉, R₃₂ |
| 47 | R₂₀, R₃₃ |
| 48 | R₂₁, R₃₄ |
| 49 | R₂₂, R₃₅ |
| 50 | R₂₃, R₃₆ |
| 51 | R₂₄, R₃₇ |
| 52 | R₂₅, R₃₈ |
| 53 | R₂₆, R₃₉ |
| 54 | R₂₇, R₄₀ |
| 55 | R₂₈, R₄₁ |
| 56 | R₂₉, R₄₂ |
| 57 | R₃₀, R₁ |
| 58 | R₃₁, R₂ |
| 59 | R₃₂, R₃ |
| 60 | R₃₃, R₄ |
| 61 | R₃₄, R₅ |
| 62 | R₃₅, R₆ |
| 63 | R₃₆, R₇ |

Table 5 can be partitioned into two regions, where the REG channel pairs {R_{X}, R_{Y}} are easily determined by the following relationships.

$$If CSN \leq 41$$

$$X = CSN + 1$$

$$Y = \{ \begin{matrix}X + 7 , & if Y \leq 42 \\ ( X + 7 ) - 42 , & otherwise\end{matrix} , \\ else \\ X = CSN - 27 \\ Y = \{ \begin{matrix}X + 13 , & if Y \leq 42 \\ ( X + 13 ) - 42 , & otherwise\end{matrix} ,$$

For example, if CSN=45, then X=(45−27)=18, and Y=18+13=31.

### Beacon Transmission Timing

FIG. 19 is a diagram of the timing and synchronization points 1900 for geographic location tracking application using HIA and REG Bursts, and for the telemetry application using HIA and REG and SIM Bursts, according to an implementation. The beacon 102 transmission of all Burst sequences utilizes a delay time between each of the Bursts. The transmission start time for each Burst is referred to as the Sync Time and the delay times are measured from the Sync Time of the preceding Burst to the Sync Time of the following Burst, as shown in FIG. 19, according to an implementation. The beacon 102 transmission of all mini-burst sequences utilizes a delay time between each of the mini-bursts. The delay times are measured from the start time of the preceding mini-burst to the start time of the following mini-burst, as shown in FIG. 19, according to an implementation.

### SIM Channel Frequency Hopping Pattern

A linear feedback shift register (LFSR) implementation of a maximum length-sequence, which ensures a uniform selection of all the SIM channels is used. The LFSR uses the generator polynomial

f*(x)=x³⁸+x³⁷+x³³+x³²+1

to generate the SIM channel hop pattern.

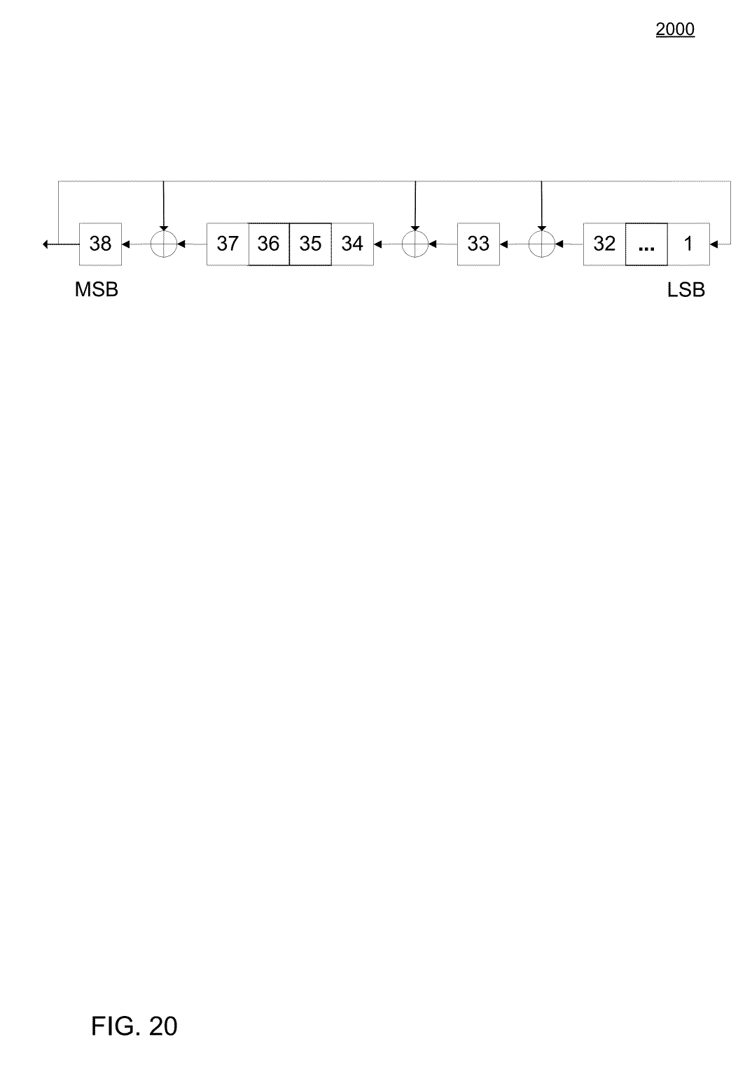

FIG. 20 is a diagram of a linear feedback shift register (LFSR) generator 2000, according to an implementation. The 32-bit WIN and 6-bit CSN are used as the initial state for the LFSR, i.e. the LFSR Register is preloaded with LFSR=[(WIN<<6)⊕CSN] and then cycled or clocked 38 times, resulting in the initial state LFSR₀. FIG. 20 shows the specified LFSR generator, which uses Galois configuration.

The LFSR are clocked 6 times to generate an index called “SIM Burst channel index” for selecting a pair of SIM channels to be utilized by SIM mini-burst₁ and SIM mini-burst₂. This index is obtained by only considering the 6 LSBs of the state register of the Galois configuration of the selected generator polynomial, which is well suited for software development of LFSRs.

As an example, let CSN=61=0x3D and WIN=123456789=0x075BCD15.

Therefore, the SIM LFSR state register is preloaded as

LFSR=[00,0001,1101,0110,1111,0011,0100,0101,0111,1101]b,

And the initial seed of the SIM LFSR state register (after 38 clocks) is

$$\begin{matrix}{LFSR}_{0} = [ 10 , 0100 , 0110 , 1111 , 1101 , 1100 , 1001 , 1101 , 0100 , 0011 ] b \\ = 0 \times 24 \; 6 FDC 9 D 43.\end{matrix}$$

Continuing the above example, 32 consecutive SIM Burst channel indices, i.e. k=[1, 2, . . . , 32] are generated, to be used by SIM Bursts which belong to a SIM Packet and are listed in Table 6:

TABLE 6
SIM Burst channel index generated
for WIN = 123456789 and CSN = 61

| k | SIM Burst channel index |
|---|---|
| 1 | 33 |
| 2 | 8 |
| 3 | 6 |
| 4 | 19 |
| 5 | 10 |
| 6 | 15 |
| 7 | 11 |
| 8 | 35 |
| 9 | 4 |
| 10 | 31 |
| 11 | 34 |
| 12 | 24 |
| 13 | 31 |
| 14 | 22 |
| 15 | 3 |
| 16 | 2 |
| 17 | 1 |
| 18 | 17 |
| 19 | 19 |
| 20 | 39 |
| 21 | 32 |
| 22 | 38 |
| 23 | 36 |
| 24 | 13 |
| 25 | 8 |
| 26 | 13 |
| 27 | 20 |
| 28 | 36 |
| 29 | 10 |
| 30 | 8 |
| 31 | 26 |
| 32 | 9 |

The SIM channels used by the two SIM mini-bursts which belong to the same SIM Burst are separated in frequency to reduce fades and interference. There are 84 SIM channels that are paired in an order such that paired channels are not repeated (i.e. the pair {Mₓ, M_{y}} is only used once in the total possible paired set and the pair {Mₓ, M_{y}} are not used).

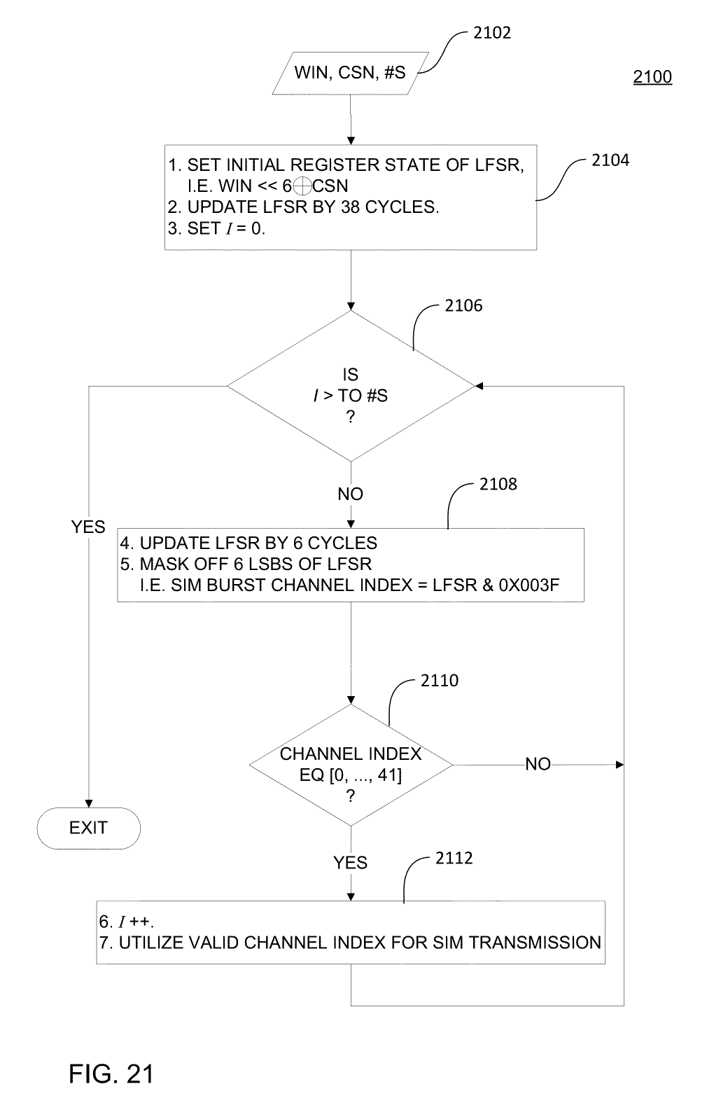

The following table is used to generate the SIM mini-burst channels from SIM Burst channel index obtained by the algorithm given by FIG. 21. There are 42 paired SIM channels. Whenever a SIM Burst channel index is generated for SIM Burstᵢ, the corresponding pair of SIM channels are picked up for SIM mini-burst_{i,1} and SIM mini-burst_{i,2}. If SIM Burst channel index is denoted by k, mathematically we can calculate the SIM channels for SIM mini-burst_{i,1}, i.e. Mₓ, and SIM mini-burst_{i,2}, i.e. M_{y} as follows:

Mₓ(k)=Mₖ₊₁, and M_{y}(k)=Mₖ₊₄₃

where Mᵢ is the i^{th} SIM channel given in Table 7.

TABLE 7
Mapping of SIM Burst channel index to SIM channels
used for SIM mini-burst₁ and SIM mini-burst₂.

| SIM Burst channel index (k) | Mₓ | M_{y} |
|---|---|---|
| 0 | M₁ | M₄₃ |
| 1 | M₂ | M₄₄ |
| 2 | M₃ | M₄₅ |
| 3 | M₄ | M₄₆ |
| 4 | M₅ | M₄₇ |
| 5 | M₆ | M₄₈ |
| 6 | M₇ | M₄₉ |
| 7 | M₈ | M₅₀ |
| 8 | M₉ | M₅₁ |
| 9 | M₁₀ | M₅₂ |
| 10 | M₁₁ | M₅₃ |
| 11 | M₁₂ | M₅₄ |
| 12 | M₁₃ | M₅₅ |
| 13 | M₁₄ | M₅₆ |
| 14 | M₁₅ | M₅₇ |
| 15 | M₁₆ | M₅₈ |
| 16 | M₁₇ | M₅₉ |
| 17 | M₁₈ | M₆₀ |
| 18 | M₁₉ | M₆₁ |
| 19 | M₂₀ | M₆₂ |
| 20 | M₂₁ | M₆₃ |
| 21 | M₂₂ | M₆₄ |
| 22 | M₂₃ | M₆₅ |
| 23 | M₂₄ | M₆₆ |
| 24 | M₂₅ | M₆₇ |
| 25 | M₂₆ | M₆₈ |
| 26 | M₂₇ | M₆₉ |
| 27 | M₂₈ | M₇₀ |
| 28 | M₂₉ | M₇₁ |
| 29 | M₃₀ | M₇₂ |
| 30 | M₃₁ | M₇₃ |
| 31 | M₃₂ | M₇₄ |
| 32 | M₃₃ | M₇₅ |
| 33 | M₃₄ | M₇₆ |
| 34 | M₃₅ | M₇₇ |
| 35 | M₃₆ | M₇₈ |
| 36 | M₃₇ | M₇₉ |
| 37 | M₃₈ | M₈₀ |
| 38 | M₃₉ | M₈₁ |
| 39 | M₄₀ | M₈₂ |
| 40 | M₄₁ | M₈₃ |
| 41 | M₄₂ | M₈₄ |

FIG. 21 is a flowchart of a method 2100 of SIM channel sequence generation per given CSN and WIN, according to an implementation.

In method 2100, a WIN, CSN and #S is received, at block 2102. The WIN is the beacon Identification Number. The CSN is the Channel Sequence number. The #S is the determined number of SIM Bursts that would be needed to transmit the encoded telemetry uplink message. Thereafter, the initial register state of LFSR is set, such as (WIN<<6) ⊕ CSN, LFSR is updated by 38 cycles, and counter I is set to I=0, at block 2104. Then, if the counter I is I>#S at block 2106, #S being the determined number of SIM Bursts that would be needed to transmit the encoded telemetry uplink message, the method 2100 ends. Otherwise, the LFSR is updated by 6 cycles and 6 LSBs are bit-masked off of the LFSR (i.e. SIM Burst channel index=LFSR & 0x003F), at block 2108. Then, if the channel index is not equal to index [0, . . . , 41] at block 2110, control returns to block 2106. Otherwise, the counter I is incremented by 1, and a valid channel index is used for SIM Transmission, at block 2112, and control is returned to block 2106. In method 2100, the length is #S×9 bytes (which can include 0x00 byte padding to make the length modulo-9 bytes for transmission on the Physical Layer). To determine the length in bits, the length is #S×9 bytes×8 bits/byte. So for the SIM frequency hopping generator shown in method 2100, it is required to generate #S valid SIM Burst channel index values for the #S SIM Bursts. Therefore, the counter value I must span 1≦I≦#S when generating the SIM Burst channel index values.

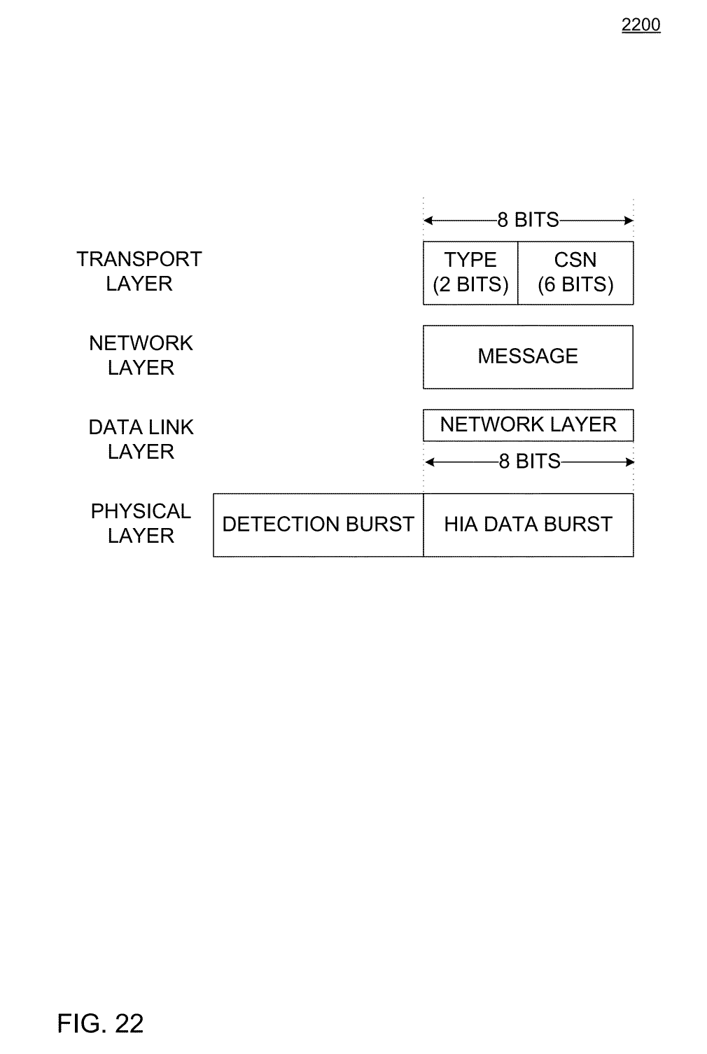

An implementation of the HIA Burst protocol stack is shown in FIG. 22, according to an implementation.

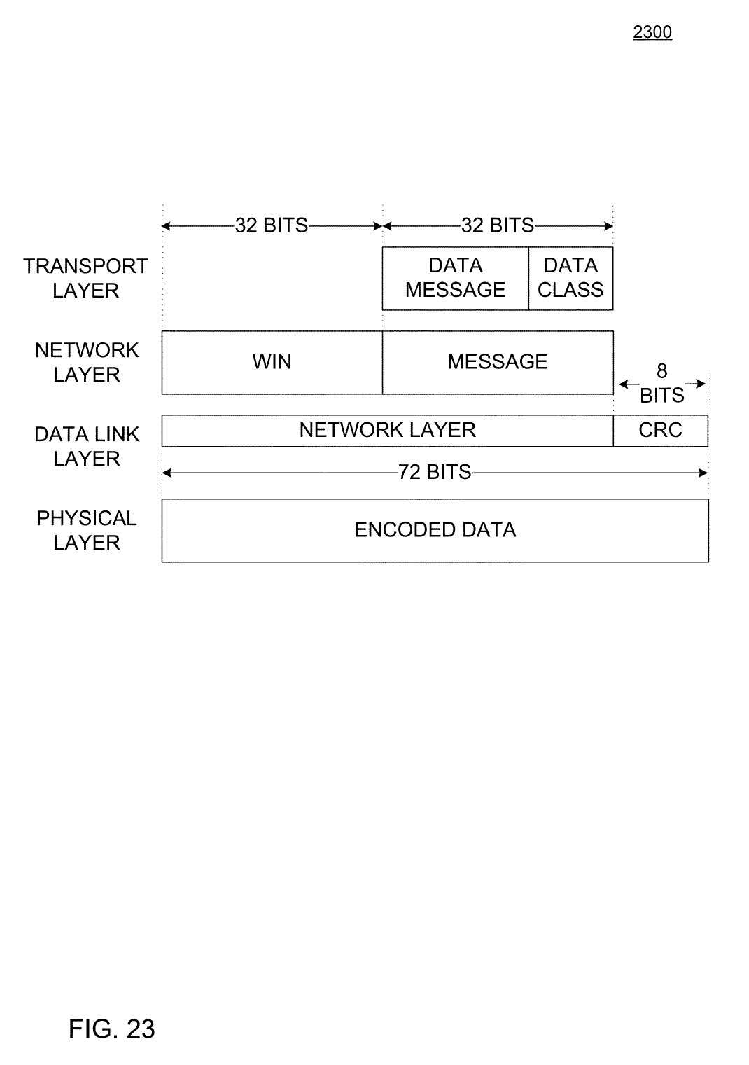

FIG. 22 is a diagram of an encapsulation of network-access related information for a HIA Burst, according to an implementation. The Transport Layer of the HIA contains the Type of HIA Burst and the Channel Sequence Number. FIG. 22 shows the HIA Burst required information, Type and CSN, referred to as the HIA Data Burst, which is combined with the HIA Detection Burst and encoded into the HIA mini-burst in the desired modulation format for transmission according to an implementation. The REG mini-burst protocol stack is shown in FIG. 23, according to an implementation.

### REG Network Layer

FIG. 23 is a diagram of an encapsulation of network-access related information for a REG Burst, according to an implementation. FIG. 23 shows the REG Burst required information, WIN, Data Message, Data Class and CRC, referred to as encoded data which is encoded into the REG mini-burst in the desired modulation format for transmission according to an implementation. The Network Layer of the REG channel includes Data Message with the addition of the beacon 102 Identification Number (WIN). The resulting number of bits from the Network Layer is 64 bits, as shown in FIG. 23.

In one example, the geographic location is a latitude and longitude and the latitude and longitude is transmitted in a 28 bit “Data Message” portion of the message layer of a REG transmission, and the “Data Class” portion of the message layer of the REG transmission is set to a 4 bit value that represent an indication of complete GNSS information of the latitude and longitude, as shown in FIG. 24.

FIG. 24 is a diagram of an encapsulation of geographic location related information 2400 for a REG Burst, according to an implementation. FIG. 24 shows the REG Burst required information, WIN, Data Message, Data Class (CRC not shown), the Data Message comprised of the beacon geographic location 116 according to an implementation.

### SIM Protocol Stack

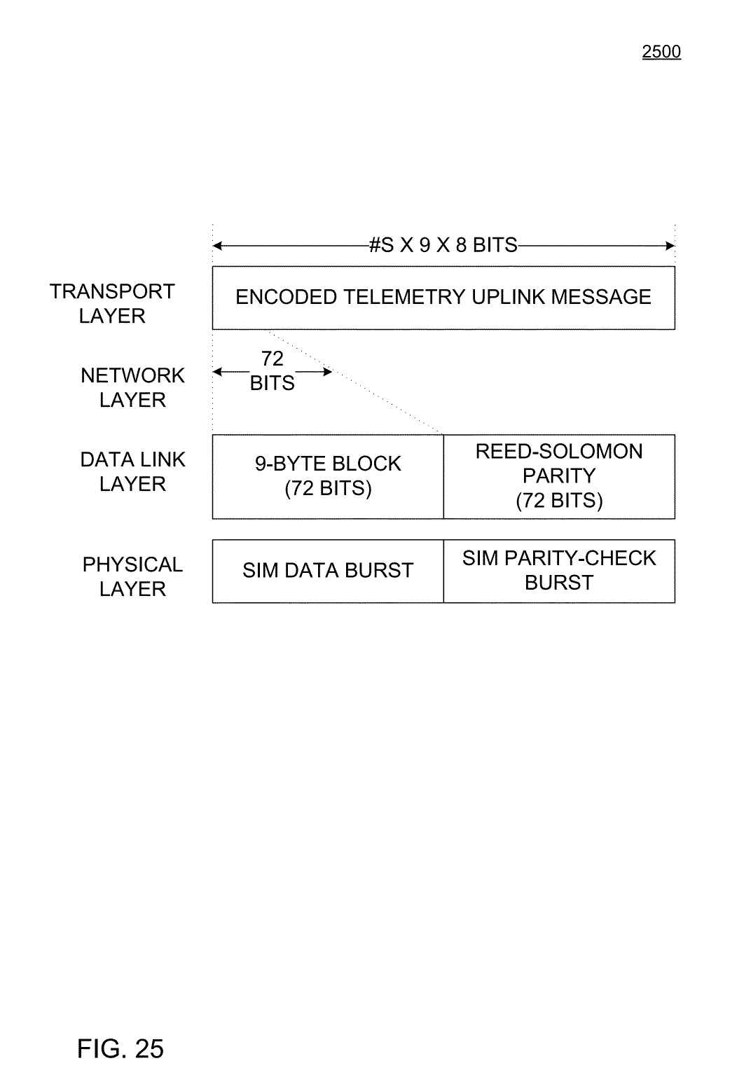

FIG. 25 is a diagram of an encapsulation of a segmented encoded telemetry uplink message 2500 for a SIM Burst, according to an implementation. FIG. 25 shows the SIM Burst required information, non-overlapping segments of the encoded telemetry uplink message and Reed-Solomon encoding, referred to as SIM Data Burst and SIM Parity-Check Burst respectively, which is encoded into the SIM mini-burst in the desired modulation format for transmission according to an implementation. The encoded telemetry uplink message is partitioned to 72-bit (9-byte) non-overlapping blocks. If the length of encoded telemetry uplink message is not a multiple of 9 bytes, then the beacon 102 adds some bytes of 0x00 to the end of the encoded telemetry uplink message. Each 9-byte block, i.e. 72 bits, are passed to the Data Link Layer for the SIM Burst transmission. The Data Link Layer corresponding to the SIM Burst utilizes Reed-Solomon encoding, i.e. “SIM Parity-Check Burst”, to implement enhanced forward error correction capability and reduce the undetected error rate.

### CONCLUSION

A wireless communication system is described. A technical effect of the wireless communication system is communication of geographic location data in bifurcated transmissions from a beacon. In some implementations, a hybrid beacon includes both a GPS receiver that generates a location of the GPS receiver and components that are operable to transmit the location in protocol to a base station receiver. Although specific implementations have been illustrated and described herein, it will be appreciated by those of ordinary skill in the art that any arrangement which is calculated to achieve the same purpose can be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

1. A computer-accessible medium having processor-executable instructions for wireless communication from a beacon to a network base station receiver, the processor-executable instructions capable of directing a processor to perform:
receiving GNSS information from a GNSS receiver;
calculating a geographic location estimate from the GNSS information, where the geographic location estimate is selected from a group of geographic location estimations in a geographical coordinate system consisting of a stationary 2-dimensional geographic location, a stationary 3-dimensional geographic location, a kinematic 2-dimensional geographic location and a kinematic 3-dimensional geographic location;
calculating a velocity and a direction of travel from the GNSS information;
transmitting a here-i-am (HIA) transmission on a first radio frequency channel of 12 radio frequency channels of a first pseudo-random frequency hopping pattern, the HIA transmission including:
identification of a second radio frequency channel of 42 radio frequency channels;
wherein the HIA transmission is a short transmission that does not include a serial number of the beacon; and
transmitting a beacon transmission that includes the geographic location, the velocity and the direction of travel,
wherein the 12 radio frequency channels and the 42 radio frequency channels are mutually exclusive and have no radio frequency channels in common between the 12 radio frequency channels and the 42 radio frequency channels.

2. The computer-accessible medium of claim 1, wherein transmitting the beacon transmission further comprises:
transmitting a registration (REG) transmission that is synchronized to the HIA transmission on a second pseudo-random frequency hopping pattern and in reference to a timing of the first pseudo-random frequency hopping pattern, the REG transmission including the geographic location, the velocity and the direction of travel, including the serial number of the beacon, including information representative of the one of the plurality of the pseudo-random frequency hopping patterns and including the information representative of the timing of the frequency hopping pattern.

3. The computer-accessible medium of claim 2, further comprising:
transmitting a short-and-instant telemetry messaging (SIM) transmission on a third radio frequency channel of the one of the plurality of the pseudo-random frequency hopping patterns and in accordance with the timing of the frequency hopping patterns, the SIM transmission including data.

4. The computer-accessible medium of claim 3, the medium further comprising processor-executable instructions capable of directing the processor to perform:
attempting receipt of an acknowledgement transmission after the SIM transmission; and
performing the processor-executable instructions of the HIA transmission, the REG and the SIM transmission that is synchronized to the REG transmission when no acknowledgement transmission is received after a period of time.

5. The computer-accessible medium of claim 1, wherein transmitting the beacon transmission further comprises:
transmitting a registration (REG) transmission that is synchronized to the HIA transmission on a second pseudo-random frequency hopping pattern and in reference to a timing of the pseudo-random frequency hopping pattern, the REG transmission including the serial number of the beacon, including information representative of the one of the plurality of the pseudo-random frequency hopping patterns and including the information representative of the timing of the frequency hopping patterns; and
transmitting a short-and-instant telemetry messaging (SIM) transmission on a third radio frequency channel of the one of the plurality of the pseudo-random frequency hopping patterns and in accordance with the timing of the frequency hopping patterns, the SIM transmission including data, the data including the geographic location, the velocity and the direction of travel.

6. The computer-accessible medium of claim 5, wherein the information representative of the one of the plurality of the pseudo-random frequency hopping patterns further comprises:
information representative of a process to generate the pseudo-random frequency hopping patterns, wherein a process is stored in the beacon and a process is stored the network base station receiver, where the processes in the beacon and in the network base station receiver generate the same pseudo-random frequency hopping pattern.

7. A method of a beacon comprising:
receiving GNSS information from a GNSS receiver;
estimating a geographic location from the GNSS information;
transmitting a here-i-am (HIA) transmission on a first radio frequency channel, to notify a network base station receiver that the beacon is in range of the network base station receiver to access the network base station receiver, to alert to the network base station receiver as to a presence of the beacon and to notify to the network base station receiver of a second radio frequency channel; and
transmitting on a other radio frequency channel a beacon transmission that includes the geographic location.

8. The method of claim 7, wherein transmitting the beacon transmission further comprises:
transmitting a registration (REG) transmission that is synchronized to the HIA transmission on the second radio frequency channel, the REG transmission including the geographic location, including a serial number of the beacon and including information representative of timing and information representative of radio frequencies in a pseudo-random frequency hopping pattern.

9. The method of claim 7, wherein transmitting the beacon transmission further comprises:
transmitting a registration (REG) transmission that is synchronized to the HIA transmission on the second radio frequency channel, the REG transmission including a serial number of the beacon and including information representative of timing and information representative of radio frequencies in a pseudo-random frequency hopping pattern; and
a short-and-instant telemetry messaging (SIM) transmission on the radio frequencies in the plurality of the pseudo-random frequency hopping patterns and in accordance with the timing, the SIM transmission including data, the data including the geographic location.

10. An apparatus comprising:
a first component of processor-executable instructions that are operable to receive GNSS information from a GNSS receiver;
a second component of processor-executable instructions that are operable to calculate a geographic location from the GNSS information;
a third component of processor-executable instructions that are operable to cause a first transmission from a beacon on a first radio frequency channel, the first transmission providing detection of the beacon by a network base station receiver; and
another component of processor-executable instructions that are operable to cause another transmission from the beacon, the another transmission including the geographic location.

11. The apparatus of claim 10, wherein the second component further comprises processor-executable instructions that are operable to calculate a velocity and a direction of travel from the GNSS information and wherein the another component further comprises:
a fourth component of processor-executable instructions that are operable to cause a second transmission from the beacon on a second radio frequency channel synchronized to the first transmission, the second transmission including the geographic location, the velocity and the direction of travel.

12. The apparatus of claim 10, wherein the another component further comprises:
a fourth component of processor-executable instructions that are operable to cause a second transmission from the beacon on a second radio frequency channel synchronized to the first transmission, the second transmission identifying the beacon and including information that is necessary to grant network access by the network base station receiver to the beacon, and
wherein the apparatus further comprises:
a fifth component of processor-executable instructions that are operable to cause a third transmission from the beacon that is synchronized to the second transmission based on the information that is necessary to grant network access, the third transmission including the geographic location.

13. The apparatus of claim 12, wherein the fifth component of processor-executable instructions further includes processor-executable instructions that are operable to cause the third transmission from the beacon on the radio frequency channel to include data, the data not including:
a serial number of the beacon;
information representative of radio frequencies of a pseudo-random frequency hopping pattern; and
information representative of a timing of the frequency hopping patterns.

14. The apparatus of claim 12, further comprising processor-executable instructions that are operable to:
attempt receipt of an acknowledgement transmission after the third transmission; and
perform the processor-executable instructions of the first transmission, the second transmission and the third transmission when no acknowledgement transmission is received after a period of time.

15. The apparatus of claim 12, wherein the fourth component of processor-executable instructions further includes processor-executable instructions that are operable to cause the second transmission from the beacon on the second radio frequency channel to include:
a serial number of the beacon;
information representative of radio frequencies of a pseudo-random frequency hopping pattern; and
information representative of timing of the frequency hopping patterns.

16. The apparatus of claim 15, wherein the pseudo-random frequency hopping pattern further comprises:
a plurality of predefined pseudo-random frequency hopping patterns being stored in a lookup table and/or a known and repeatable algorithmic process on a second computer-accessible medium.

17. The apparatus of claim 15, further comprising processor-executable instructions that are operable to:
perform the processor-executable instructions of the first transmission and the second transmission without processor-executable instructions to wait for an acknowledgement transmission after the processor-executable instructions of the first transmission and the second transmission.

18. The apparatus of claim 10, wherein the third component of processor-executable instructions further includes processor-executable instructions that are operable to cause the first transmission from the beacon on the first radio frequency channel to include:
notice that the beacon is in range of the network base station receiver;
a representation of imminent access to the network base station receiver; and
identification of a second radio frequency channel.

19. The apparatus of claim 10, wherein the third component of processor-executable instructions does not further include processor-executable instructions that are operable to cause the first transmission from the beacon on the first radio frequency channel to include:
a serial number of the beacon;
information representative of radio frequencies of a pseudo-random frequency hopping pattern; and
information representative of timing of the frequency hopping patterns.
